(19) United States
(12) Patent Application Publication
(10) Pub. No.: US 2014/0349260 A1
(43) Pub. Date: Nov. 27, 2014

(54) Promises tracking device and method thereof for enhancement of behavior control

(71) Applicant: Deborah L. HILL, Sunland, CA (US)

(72) Inventor: Deborah L. HILL, Sunland, CA (US)

(21) Appl. No.: 13/986,690

(22) Filed: May 24, 2013

(51) Int. Cl. G09B 5/00; G09B 19/00

(52) U.S. Cl. CPC G09B 5/00; G09B 19/00
USPC 434/236

(57) ABSTRACT

A method of tracking promises from a user, which includes the steps of providing a learning and training phase to the user for learning promise techniques, recording a plurality of viable promises made by the user in a chainlike manner to form a promise chain; guiding the user to keep each of the viable promises from the promise chain; and determining a promise score of the user regarding to the promise chain, which is an incentive to motivate the user to keep the promise score as high as possible, wherein when one of the viable promises is broken, the promise chain is then broken to have a negative affect on the promise score.

### CROSS REFERENCE OF RELATED APPLICATION

This is a Continuation-In-Part application that claims the benefit of priority under 35 U.S.C. §119 to a non-provisional application, application Ser. No. 10/222/321, filed Aug. 16, 2002.

### BACKGROUND OF THE PRESENT INVENTION

1. Field of Invention

This invention relates to a “promises tracking device” and method thereof for enhancement of personal control to help people increase their levels of success at performing desired behaviors.

2. Description of Related Arts

The problem solved by my invention can most easily and clearly be described by using an example of a person with the problem. To illustrate a preferred embodiment, I will use the example of an over-eater (an individual who eats too much due to a lack of personal control), who I will call Albert. In this example, fat Albert is sitting on his sofa in his living room, trying to resist having some pie that's not allowed on his diet. (Let's say the pie is available in his kitchen because a member of his family, who is not on a diet, brought it home.)

Albert will have to try to resist his desire for pie as his powerful mind stimulates him to have it by:
flashing mental pictures of the pie into his consciousness;
giving him cravings, urges, ideas and plans for having it;
sending him memories of how rich and creamy it tastes, as well as memories of feelings of enjoyment and well-being he derives from eating such comfort foods;
making his mouth water when he thinks about eating it;
making sure that he notices other family members enjoying it;
creating a mental and physical state of readiness for it (such as quickening his heart rate and enlarging his pupils when he sees it);
giving him rationalizations and excuses for making an “exception” to his diet;
proposing deals for making an exception to his diet. For example proposing a deal that if he has the illegal sweet “today,” he will not eat any sweets “tomorrow.” (Such deals are often not kept, since Albert's mind will work just as hard for the next temptation!);
minimizing the negative consequences of having the pie;
maximizing the positive aspects (the pleasures) of having the pie.
creating a sense of urgency to have the pie.
intensifying the stimulations for having some of that pie;
sending him urges to take steps in the direction of his kitchen, and urges to reach out to take some;
altering other known and unknown bodily chemicals and nerve impulses to assist in increasing and obtaining the desire for him;
altering his mood so that he feels that he can't accept doing without it;
creating situations and scenes that will help get him the pie he desires;
making him feel unbearably sad, deprived—or even angry if he doesn't get some!
Etc.

Note: I refer to the above mental pictures, memories, moods, senses, ideas, plans, rationalizations, chemicals, nerve impulses, etc. as the “mind-tools.” The mind-tools include all the “abilities” that the mind can use to stimulate people to act.

The above example illustrates just how incredibly difficult and unpleasant it is for Albert (and others) to resist temptations that they feel they shouldn't have. No wonder they fail, again and again! (Over-eaters should not be confused with people who have personal control over how much they eat.)

The reason the mind works for things we desire, even when we feel we shouldn't have them (whether it be excess food or alcohol; cigarettes; illegal drugs; to play hooky, etc.) is well known. Put simply, the primitive mind is ruled by the “Pain and Pleasure Principle”: it seeks pleasure and to avoid pain. So it has a natural tendency to work for whatever we find pleasurable. In the case of fat Albert, food is high on his list of things that bring him pleasure. So, once a desire for an available food temptation is kindled in his mind, he must “fight” his primitive mind to try to resist it, which can make it very difficult and unpleasant for him to resist!

The primitive mind is so powerful that when it works for such desires, success rates for resisting them are often very unreliable and low. And even if Albert is able to resist many temptations, he can make up for most or all of the progress he has made on his diet in a few moments, hours or days of weakness! This is the reason for the current runaway obesity epidemic in the United States and other developed countries.

So the question is: What prior art methods are available to help people, like Albert, resist inappropriate temptations so that they can stick to their diet, exercise and other plans to obtain their goals? The following discussion of the prior art will explain why none of the previous methods can be relied on for control in personal situations which require willpower (as in the example of fat Albert sitting on his sofa, trying to resist the pie in his kitchen).

All previous methods attempt to either: fight the mind; change the mind; suppress the mind; or deal with the damages caused by the mind. (These are the same methods that people use to try to control other kinds of personal behaviors, with equally low success rates.)

Methods which attempt to “fight” the mind are designed to help the over-eater fight the stimulations that his primitive mind sends. These methods include: DIETS; SUPPORT METHODS; BARRIERS AND AVOIDANCE SYSTEMS; and WILLPOWER. The following chart describes some of the problems of these methods that my invention solves or significantly improves:

| PREVIOUS METHOD: | PROBLEMS RELATED TO THIS METHOD: |
|---|---|
| DIETS: | The restriction and deprivation of diets only increase the stimulations |
| | from the primitive mind that the individual will have to fight! Diets which |
| | restrict certain foods (such as low carbohydrate or low fat diets) are usually |
| | ineffective, since (thanks to the primitive mind) people often begin to experience |
| | extremely strong cravings for the food combinations that they prefer and, |
| | sooner or later, give into them. |
| | Very low success rates. It is now widely acknowledged that DIETS DON'T |
| | WORK! Long-term success rates of even 3% are rare. These low success rates |
| | are well documented. Decades ago, the Washington Post reported that only one |
| | individual out of every 200 who go on a diet will lose all the weight they set out |
| | to and keep it off for any reasonable length of time. That's a 99.5% long-term |
| | failure rate - and things have only gotten worse! Most studies report that less |
| | than 10% of dieters can maintain even a 5% loss from initial body weight for 5 |
| | years. For example, of those who start at 250 pounds, less than 10% can maintain |
| | a loss of even 12.5 pounds for 5 years! Of those who start at 150 pounds, |
| | less than 10% can maintain a loss of even 7.5 pounds for 5 years! As a result, |
| | the prevalence of obesity in the United States is only increasing - up 33 percent |
| | in the past decade alone! |
| | Diets are very stressful and difficult to follow. Stimulations from the primitive |
| | mind makes diets so stressful and difficult to follow that over-eaters frequently |
| | break or quit them. Then they can regain all the weight they may have |
| | lost in a few hours, days, or weeks of unrestricted eating - and may even put |
| | on more weight! |
| | Diets tend to make people more obsessed with the foods and quantities |
| | they shouldn't have. This can lead to obsessive, compulsive eating disorders, |
| | binging and purging, which can have severe physical and psychological con- |
| | sequences. Very often, people gain all their weight back, plus “a little more” |
| | each time they diet; and it becomes more difficult to start and succeed each |
| | time they try, due to these resulting eating disorders. |
| | Dieting can be unhealthy. Doctors now discourage very low calorie medically |
| | supervised diets (as were frequently prescribed in the recent past). According |
| | to the Merck medical manual, studies have shown that “ . . . people tend to |
| | regain weight after going off the diet.” There is evidence that these diets, and |
| | yo-yo dieting, may damage a person's gallbladder, metabolism, etc. |
| | People on low carbohydrate diets may increase their risks for cancer, heart |
| | disease and other health problems, since these diets encourage more animal |
| | proteins and fats, and less healthy fruits and vegetables. (A single apple has all |
| | the carbohydrates many low carbohydrate diets may allow in a day, and the |
| | dieter would rather spend his “daily allotment” of carbs on nutrient-poor |
| | bread, pasta, sweets, chips or beer, instead of a healthier choice.) |
| SUPPORT | These methods are intended to help people fight the stimulations that their |
| METHODS: | minds send to tempt them off their plans. The over-eater can seek support from |
| | his doctor, a counselor, a software program, motivational meetings, a personal |
| | trainer, an online group, a “call buddy system,” etc. Such programs work best |
| | when they stress the negative aspects of the undesirable habits, educate about |
| | preferable ones and give motivation, such as U.S. Pat. No. #4,344,625: Game |
| | Encouraging Self-Improvement. |
| | Meetings and Appointments: |
| | These can be expensive and inconvenient. There may be little or no support |
| | between meetings (when support is needed most). Setbacks are so common |
| | that dealing with them is built into the program! |
| | People who hire expensive personal trainers for support must schedule and |
| | keep appointments and are often embarrassed to sweat and grunt in front of a |
| | perfectly toned trainer, which can cause them to quit. |
| | Computerized Programs: These can provide support for all aspects of planning, |
| | starting and following a weight loss plan; giving motivation, tips and |
| | incentives (such as rewards and punishments), such as Interactive Goal- |
| | achievement System and Method, U.S. Pat. No. #5,697,790. But it takes a |
| | very disciplined individual to enter all the data into a computer and keep up |
| | with it constantly (over-eaters often lack the self-discipline). And the token |
| | tips, rewards and punishments are no match for the powerful primitive mind |
| | when it is working for a desire! After each failure, it's difficult and unpleasant |
| | to log in! |
| | “Buddy Systems”: These offer support during moments of temptation. For |
| | example, when Albert is sitting on his sofa trying to fight off his desires to |
| | have that piece of pie, he can log on to a chatroom or call a “buddy” to try to |
| | talk him out of it. But when Albert is tempted by a food desire, he will have to |
| | fight his mind just to log on or call his “buddy.” If he succeeds at taking that |
| | step, the buddy may or may not be able to talk him out of it. And even if that |
| | works, Albert's powerful mind can break down his willpower a few minutes or |
| | hours afterwards - a common occurrence! |
| BARRIERS AND | These methods attempt to create some kind of physical barrier between the individual |
| AVOIDANCE SYSTEMS: | and temptations. |
| | Keeping Temptations Out of One's Environment: Albert could try to keep |
| | tempting pie out of his house. Variations of these plans include avoiding certain |
| | aisles in grocery stores, locking foods up and keeping junk foods out of schools. |
| | But these methods are highly impractical and unreliable in today's modern society. |
| | Albert won't be very popular with his family if he asks them not to bring |
| | home any food that's not allowed on his diet! And he'll still have to fight his |
| | mind to avoid tempting locations; or could be surprised by them in the lunch |
| | room or at a party or meeting. There are no “eating police” to stop him from |
| | going out for them himself when tempted! |
| | Weight Loss Resorts: People can check in to so-called “fat farms,” (resorts |
| | where only healthy, low-calorie portions are served) for days or weeks. But |
| | such places don't usually change a person's eating habits; and people can't |
| | stay in them forever. When they are released, they often return to their old |
| | habits and the weight returns. (Anyone who has ever stayed in such a place |
| | knows that their mind is so powerful that it can almost always find a way to |
| | get them forbidden temptations - like a $50 smuggled-in brownie!) |
| | Bodily Restrictions: Stomach capacity reduction surgeries do temporarily |
| | stop the mind from sending stimulations to eat too much by actually making it |
| | painful and dangerous for the over-eater to do so! But these procedures are |
| | expensive and carry significant physical (and even psychological) risks. |
| | Weight can quickly be regained as soon as the patient realizes that he can eat |
| | just as many calories each day by eating smaller portions more often or fattening |
| | foods in a liquid or semi-liquid state (mocha latte shakes and soft creamy |
| | pasta). The stomach and esophageal walls also tend to stretch over time, canceling |
| | out the food capacity-limiting effect. |
| | Wiring teeth shut make it difficult to speak - and people quickly learn that |
| | straws can deliver high calorie ice cream shakes right through them! |
| | Limited Portions of Food: Modern versions of the barrier method include buying |
| | portioned meals or having them delivered to one's home to limit portions. |
| | But people often dislike the taste of these low-fat, low-calorie, high fiber foods |
| | or simply start craving their own favorite brands, recipes and quantities. There |
| | are no “eating police” who will burst onto the scene and prevent Albert from |
| | eating more than his boxed portion. If he isn't full or wants something else, he |
| | will have to fight his powerful mind to try to stop eating! |
| WILLPOWER: | All of the above methods ultimately depend on ordinary willpower. When |
| | Albert is trying to resist the stimulations his mind is sending him to have that |
| | piece of pie, he will have to fight his mind, using unreliable, wavering, will- |
| | power. Willpower can be strong when a person is motivated, but weak and |
| | unreliable when the person is tempted - just when he needs it most! And because |
| | the mind-tools give the primitive mind nearly limitless power, failure is |
| | common. |
| | Willpower is a relatively easy obstacle for the powerful primitive mind to |
| | overcome to get people to give in to their desires. In fact, who knows a person |
| | better than his own mind? Albert's mind knows just the right rationalizations |
| | to use to get him to give in to that pie. It knows just the right moods to |
| | put him in; the right scenes to create; and the best plans and ideas to send into |
| | his consciousness to tempt him to have it. Even if he succeeds at resisting, it |
| | will be a very difficult, stressful and unpleasant experience for him. |

Methods which attempt to “change” a person's mind endeavor to reduce or eliminate the urges sent by his mind to do what he feels he shouldn't do. These include: EDUCATION; BEHAVIOR MODIFICATION; ANALYSIS (of one's childhood or past); HYPNOSIS AND POSITIVE AFFIRMATION METHODS; POSITIVE REINFORCEMENT AND FEEDBACK METHODS; REHEARSAL METHODS; SELF ESTEEM TRAINING and THE SHIELD METHOD. The following chart describes some of the problems of these methods that my invention solves or significantly improves:

| PREVIOUS METHOD: | PROBLEMS RELATED TO THIS METHOD: |
|---|---|
| EDUCATION: | Teaching people that fatty, sugary food is bad for them can reduce the urges |
| | to have it for some, but not usually for over-eaters. Over-eaters typically eat |
| | based more on what they currently want (instant gratification), rather than |
| | what's good for them. Just teaching fat Albert that certain foods are healthier |
| | does not mean that he will choose them! Albert will have to fight his mind |
| | to try to resist having the pie he wants, regardless of how much he knows he |
| | shouldn't have it. His knowledge will only increase his feelings of guilt and |
| | deprivation. Healthier foods are generally more time consuming to prepare. |
| | Low fat foods don't taste as good and aren't as satisfying as the fast, easy, |
| | high caloric foods that are constantly advertised to consumers. Companies |
| | that produce low fat foods are reporting that people have been turning away |
| | from their products and buying foods that taste better. |
| BEHAVIOR | Behavior modification methods, such as U.S. Pat. No. #5,207,580: Tailored |
| MODIFICATION: | Health-related Behavior Change and Adherence Aid System, attempt to |
| | teach the over-eater to eat without distractions, eat more slowly, take small |
| | bites, put his fork down between each bite, etc. But this will not guarantee |
| | that the over-eater will do it. Fat Albert's primitive mind will fight such restrictions. |
| | Setbacks are common; and significant long-term improvements |
| | are rare, especially for over-eaters. |
| ANALYSIS (OF | Blaming previous experiences for negative behaviors is controversial. Fat |
| ONE'S CHILDHOOD, | Albert may have had a traumatic experience when he was young, but psychologists |
| ETC.): | disagree as to whether or not this could have caused his eating |
| | problem. Even if a lack of personal control can be traced to a past experience, |
| | this does little to correct the problem. Years of therapy aimed at correcting |
| | the problem are often plagued by setbacks. However, there is little |
| | doubt that a lack of personal control can cause physical and psychological |
| | problems. Albert's inability to control how much he eats will almost certainly |
| | lead to physical ailments, anxiety, low self esteem, depression and even |
| | obsessive-compulsive tendencies. The real problem is often a lack of reliable |
| | personal control! |
| HYPNOSIS AND | Fat Albert can be given a hypnotic suggestion to have an apple for dessert |
| POSITIVE AFFIRMATION | (instead of chocolate cake). Or, he may repeat such positive phrases (or |
| SYSTEMS: | affirmations) to himself. However, these methods have been shown to be |
| | highly ineffective ways of improving behavior for over-eaters, in both the |
| | short and long-term. The over-eater's preference for chocolate cake is often |
| | much stronger than a hypnotic suggestion. When these methods work |
| | it is often because of the placebo effect: the individual has been told by an |
| | “expert” that they will work; and the effect does not usually last. |
| POSITIVE REINFORCEMENT | Low success rates persist, despite supportive positive reinforcement (or |
| AND | feedback) systems, such as U.S. Pat. No. #5,954,510; and negative reinforcement |
| FEEDBACK METHODS: | (or feedback) systems, such as the pain-induced electrical punishment |
| | system applied to the skin while the patient engages in undesirable |
| | behaviors and is told their negative qualities, “The Schick Method.” |
| | Some of these methods utilize equipment that is similar to pilot training |
| | simulators to help people know and practice what to do in specific situations. |
| | Fat Albert can watch a simulated scene and use a keyboard, a toggle |
| | switch, or be wired so that he can react to the scene. For instance, the |
| | screen may show him walking into a simulated break room and - uh oh - |
| | he is surprised by the enemy: an open box of donuts! He practices doing |
| | “the right thing”- grabbing a celery stick and walking away - and then |
| | records how much better he feels about doing so. This is repeated in an effort |
| | to strengthen nerve synapses for more desirable behaviors. |
| | In this way, a simulator can help the over-eater know what to do at a time |
| | of temptation. But this cannot reliably eliminate the mind battles that he |
| | must fight in the real battlefields of temptation, or guarantee that he will |
| | succeed. What fat Albert will do depends on whether or not he can win the |
| | fight against his infinitely powerful mind. When he really wants a food |
| | temptation, his primitive mind will usually succeed at getting it for him! |
| | These methods are similar to all systems that are designed to help people |
| | rehearse doing the “right thing,” such as hypnosis, positive affirmations, |
| | counseling, journaling, meetings, etc. But the primitive mind can easily |
| | override even strong nerve impulses when working for desires. Such is the |
| | case when fat Albert wants pizza on a cold night and has to go out for it. His |
| | mind can override his strong impulses to stay warm, dry and comfortable; |
| | and can help him dress and brave the weather. |
| SELF ESTEEM | Behavioral scientists noticed that people who feel good about themselves |
| TRAINING | have higher levels of personal control. So they worked on increasing the self |
| | esteem of over-eaters, theorizing that this would give them greater personal |
| | control. But this yielded disappointing results. It's just plain hard for an |
| | over-eater, like Albert, to feel good about himself when he keeps losing control! |
| | However, it is well known that increasing personal control (as with my |
| | invention) can increase self esteem dramatically! |
| THE SHIELD | There is one new method that can significantly increase personal control: |
| METHOD: | the Shield Method, for which a patent application (number 10/222,321 has |
| | been submitted. This invention is mostly a mental method, although it |
| | does include an essential manual step which manipulates mental and physical |
| | results. And it does not utilize technology. The invention of the present |
| | application is essentially the same, but includes a software program in |
| | computerized device (such as an “iPhone App” in the preferred embodiment). |
| | This gives significant advantages, since it can instruct; record and |
| | compare performances; give personalized, timely motivation, tips, reminders; |
| | trouble shoot; etc. |

Methods which attempt to “suppress” the mind include those which try to suppress hunger or desires, such as HUNGER SUPPRESSANTS and DESIRE SUPPRESSANTS. The following chart describes some of the problems of these methods that my invention solves or significantly improves:

| PREVIOUS METHOD: | PROBLEMS WITH THIS METHOD: |
|---|---|
| HUNGER | According to the Merck Medical Manual, regarding hunger suppressants |
| SUPPRESSANS: | such as amphetamines, “There is a danger in using these drugs because |
| | they simultaneously overexcite the central nervous system, making the |
| | person nervous and elevating blood pressure. Also, a person soon adapts to |
| | the drug, so that weight reduction is usually no more than 5 to 10 percent.” |
| DESIRE | The prior art includes some methods designed to reduce desires for temptations, |
| SUPPRESSANTS: | such as dulling the taste buds or blocking smell, so that food |
| | doesn't taste as good. These methods never became very popular because |
| | they prevented people from enjoying eating, which is especially important |
| | to the over-eater! |

Methods which attempt to “deal with the damages” caused by the mind's stimulations don't attempt to stop the negative behaviors; they simply try to deal with the aftermath—the resulting weight gain obesity, low self esteem, health problems, etc. These include EXERCISE; FAT AND SUGAR BLOCKERS; PRESCRIPTION DRUGS; GIRDLES AND “SLIMWEAR”; and SELF-ACCEPTANCE TRAINING. The following chart describes some of the problems of these methods that my invention solves or significantly improves:

| PREVIOUS METHOD: | PROBLEMS WITH THIS METHOD: |
|---|---|
| EXERCISE: | After failing on many stressful diets, Albert could decide to just give up on |
| | dieting and run 10 miles a day to “burn off” all the calories he eats. But excessive |
| | exercise is very stressful to the body. It could wear out or injure his |
| | joints. Also, exercise is simply not very effective. Despite what exercise |
| | promoters lead people to believe, it's a medical fact that it takes 17 days of |
| | doing one hour of “active exercise” (like brisk walking, calisthenics or using |
| | a recumbent bike) to lose a single true pound of fat! That's why advertisements |
| | for exercise methods almost always refer to them as a “plan”- which |
| | includes a reduced calorie diet. Unfortunately, it only takes one day - or a |
| | few hours - of eating excessively to regain a pound lost by weeks of exercise! |
| | So exercise is not a solution for those who continue to over-eat! |
| FAT AND SUGAR | These often have unpleasant side effects (such as bloating and “leaking |
| BLOCKERS | anus”); and they often result in compensating, as happened with the advent |
| | of sugar substitutes. (Fat Albert could rationalize that he is “saving” |
| | calories and eat more). These products usually only block small amounts |
| | of fats and sugars, so the net result is often weight gain and the dissatisfied |
| | user stops using them. |
| PRESCRIPTION | Fat Albert could ask his doctor to give him something to rev up his body's |
| DRUGS: | metabolism so that it will “burn off” the excessive calories he eats. But, according |
| | to Merck Manual, “Generally, such a drug reduces weight by about |
| | 10 percent within 6 months and maintains the loss as long as the drug is continued. |
| | When it's discontinued, the weight is promptly regained.” These drugs |
| | also carry substantial side-effect risks, which is why their use must be prescribed |
| | and closely monitored by a physician. |
| | Many doctors will not give Thyroid (the hormone that increases metabolism), |
| | because so much is required that it gives extreme side-effects. Additionally, |
| | the body will respond by lowering the thyroid output even further, canceling |
| | out its effect. Even if it were easy to significantly increase metabolism, there |
| | would be other negative effects, such as accelerated aging and increased risks |
| | for disease. (Accelerated cell replication would result in accelerated replication |
| | mistakes, resulting in faster aging and diseases like cancer.) |
| GIRDLES AND | Because the prior arts have failed, this option has come into vogue. However, |
| “SLIM WEAR” | they can't really hide the ugly truth or reduce the health hazards of |
| | obesity, and don't really solve the problem. |
| SELF-ACCEPTANCE | The physical and mental stresses of dieting can be so severe that the dieter |
| TRAINING: | may conclude that it's better to just learn to accept himself as is. Indeed, dieting |
| | can actually increase the stimulations from the primitive mind, resulting |
| | in eating disorders that can make the over-eater obsessed with foods. But it's |
| | difficult for over-eaters to accept their unhealthy, unattractive bodies; and |
| | accept themselves as failures. This is not the solution they prefer. |

In conclusion, none of the above prior art methods can be relied on to help people resist available temptations in personal situations. Although all methods work some of the time for some people, none work reliably or give lasting results for most people—otherwise we wouldn't have an obesity epidemic! Despite the vast body of information and technology that modern society has to offer, it is still very difficult and unpleasant for people like fat Albert to resist excessive food desires—because the primitive mind is so powerful and relentless—and their success rates for resisting are still extremely low and unreliable!

Failure is just as prevalent when it comes to following other kinds of personal plans. The majority of people who join gyms or buy exercise equipment don't use them for more than a few days or weeks, because their primitive minds fight their plans! People also have to fight their minds to follow plans to eliminate drug and alcohol abuse, to stop smoking, etc., resulting in the same low and unreliable success rates. Very few people can stick to their self improvement plans long enough to achieve the results they want. An effective method is desperately needed!

My invention solves (or is a substantial improvement over) all of the problems listed in the above prior art charts, as will become apparent in the following description.

### SUMMARY OF THE PRESENT INVENTION

My invention enables people to program their minds to “help” them resist temptations so that they don't have to “fight” their minds in order to resist them. THIS SHOULD NOT BE CONFUSED WITH PREVIOUS NEBULOUS, UNRELIABLE METHODS THAT CLAIM TO BE ABLE TO PROGRAM THE MIND, SUCH AS SELF HYPNOSIS AND POSITIVE AFFIRMATIONS. My method provides TRUE, IMMEDIATE and UNDENIABLE mental programming, as certified by a panel of psychologists and medical doctors who participated in a clinical test.

By enabling people to reliably program their minds to help them resist temptations, my invention allows them to easily, comfortably and reliably withstand temptations that would otherwise be very difficult and unpleasant for them to resist; and it can give much higher success rates for following behavior plans. Therefore, my invention overcomes the major problems of the prior art: lack of reliable personal control, discomfort while resisting temptations and low success rates for sticking to behavior plans.

My invention is the first that enables people to activate the same mentally programmed state of mind that the mind naturally activates to help people resist temptations easily, comfortably and with a very high degree of reliability.

To illustrate this mentally programmed state of mind, I will describe how the mind already naturally uses it to control eating behaviors. Let's put fat Albert (the over-eater described throughout this Specification) in one of those “big box” stores, like Costco, approaching a table where savory crackers topped with a delicious dip are being given out as samples. In this situation, since he is sure that he can only take one sample; his mind will be programmed to help him resist having more. Then, even an over-eater like Albert will be able to stay in control. It will be relatively easy for him to have just one sample, and he will be able to resist taking more. Even those who would go back for another sample, or two, will not start eating the food uncontrollably, like they might do at home—have you ever seen anyone lose control and be unable to stop eating at a sample table?

Note that because Albert's mind is programmed to help him resist taking more than the socially acceptable amount in this situation, he will not have to fight his mind to resist taking more. In fact, his mind will be “switched” to helping him resist more; by using its mind-tools to help him accept that he can only have the limited amount and keeping him as comfortable as possible with just that much. (One of the bonuses of this is that his mind will help him really concentrate on and enjoy the flavors and textures of the small sample—a benefit that sample-givers count on!) His mind will help him easily and comfortably stay in control, while giving a remarkably high success rate for resisting more.

Feeling sure that he could only have one sample is what activated the programmed mental state that kept the over-eater comfortable with the small amount, since “feelings of sureness” program the mind. But notice that this was a public (social) situation. There has never been a practical or reliable way for people to create this sureness, which can activate this natural ability of the mind, in personal situations that require willpower.

Actually, there are ways to create this kind of sureness for personal control; but they are not practical or reliable. Let's say fat Albert buys some of those crackers and dip from the big box store. When he gets them home, he could pour them into a large bowl and then pour molasses—no, motor oil—all over them and stir it all up, being careful to coat every cracker and completely saturate the dip with the oil. Mmmm! This would certainly create the “sure” state of mind that he wouldn't eat them, which would program his mind to make it easy for him to resist them!

But, as I said, this method isn't practical or reliable. Albert would have to use willpower to pour motor oil over the crackers and dip (he'd have to fight his mind to do it); so there would be no advantage. And even if he were to succeed at saturating them with the oil, there would be plenty of other food temptations in his cupboards—or nearby 24 hour convenience stores—to pig out on! Also, he'd be wasting food. Why buy food to waste it? This is why there has never been a practical or reliable way to accomplish this kind of personal sureness to program the mind, before my invention.

Here are more examples of how “sureness” programs the mind; and how this can make unpleasant behaviors that the primitive mind would fight much easier and more comfortable to accomplish, while giving very high success rates—usually over 99%!
a. Because drivers feel sure that they must keep their eyes on the road and their hands on the wheel while driving, their minds are programmed to help them do so rather than fighting this behavior. This enables them to cruise down freeways at high speeds for hours at a time, within a few feet of large SUV's and 18 wheeler trucks, as comfortably as possible, without making a serious driving mistake—over 99% of the time! (Compare this to dieters who typically have eating accidents and diet crashes daily!)
b. Because most mothers feel sure that they must change their babies diapers promptly, to protect them from discomfort, diaper rashes and unsanitary messes, their minds are programmed to help them accept that they must do this unpleasant task and help them accomplish the job, as comfortably as possible!
c. It's not easy to feed, house and clothe a child 365 days a year; but because parents feel sure that they must (due to social, religious and other influences), their minds are programmed to help them do it. This enables them to take care of their children every single day, as comfortably as possible, and even, often, to find joy in doing so!
d. Because soldiers feel sure that they will engage the enemy when ordered to, their minds are programmed to help them follow this very difficult behavior, as comfortably as possible, enabling them to accomplish great acts of bravery in combat situations.
e. If a driver feels sure that he is about to go through his front windshield in an accident, his mind will be programmed to take every conscious and instinctual action it can to help him survive, as comfortably as possible. This may include blacking out the memory from his conscious mind to help him cope.

Note: the programmed mind can't always make people completely comfortable while doing unpleasant things, but it will work to keep them as comfortable as possible.

Scientific Description:

This programmed mental state is described in the field of psychology in terms of the id, the ego and the superego, the three divisions of the mind or psyche.
a. The id is the primitive mind (instinctual drives).
b. The superego represents the moral standards and ethics that you believe in. It rewards you with good feelings about yourself when you meet these standards, and makes you feel bad when you don't.
c. The ego mediates between the above two divisions of the mind.

To clarify, think of the example of an over-eater, like fat Albert, approaching the sample table at Costco. Although he would prefer to eat samples without restriction (a primitive id desire), he feels sure that he can't in this situation (because of a strong social superego influence), so his ego programs his mind to forego (and protect him from) the id desire. This makes it easy and comfortable for him to resist having more. Only severely mentally impaired people can't do this.

Terminology:

I have named the above described sure programmed state of mind a “Mental Shield,” since it protects (or Shields) behaviors; and protects (of Shields) people from feeling uncomfortable without desires. Specifically, a Mental Shield is a programmed state of mind, which is acting to protect a person, plan, behavior or belief. Mental Shields are automatically and naturally activated by the mind whenever we feel “absolutely sure” that we can't (or won't) have something that we might desire. They act to make us as comfortable as possible without the things we feel we can't (or won't) have.

I named my method of activating and using Mental Shields “The Shield Method.” To help teach the Shield Method, I use words based on “Shield,” in various ways as nouns, verbs, etc., like “Shielder,” “Shielded” and “Shielding.” For example, we refer to people who learn and use the Shield Method as “Shielders” and when a Shielder activates a Mental Shield, we say that they are “Shielded.” To distinguish this terminology, I will capitalize the first letters of all words relating to “Shielding” in this application.

Obviously, it is much easier to resist a temptation when our powerful mind is programmed to help us resist it than when it is working for the temptation!

It's important to note that this sure-programmed state of mind is not unusual or stressful. It's naturally and comfortably activated in humans all the time, such as when we go to sample tables; or get dressed before going out into public (we feel sure that we must go to the trouble of getting dressed before going out, which programs our minds to help us do it, as comfortably as possible, and we succeed over 99% of the time!).

This “Mental Shielding” is the method that the mind naturally uses to make us comfortable when we feel sure that we can't have something that we might desire. It also enables us to accomplish tasks and goals that require suppression of our primitive impulses. It provides much greater ease, comfort and reliability than any man-made method of personal control, so it's highly desirable to be able to activate it reliably and “at will,” as only my invention achieves. Man made methods, such as diets, cause stress and typically only achieve success rates of less than 3%. Mental Shielding, however, typically makes resisting temptations easy and comfortable; and gives success rates greater than 99%!

People are often able to create this sureness when they are motivated to do something. The problem is that they usually can't maintain it. For example, when most people start a weight loss or exercise plan, they are highly motivated and able to manufacture a sure state of mind that they will follow it. This programs their mind to help them to follow their plan, at first. But when the behavior becomes unpleasant, the primitive mind will start fighting their plan, giving urges, rationalizations, etc. to stop it. Then they will have to fight their powerful primitive mind, using ordinary wavering willpower, to try to stick to their plan.

As described in the original application, the object of my invention is to help people create a new reliable superego influence, so that they can activate this natural Mental Shielding ability of their minds “at will.”

It was the “social” superego influence that enabled the over-eater at the sample table to feel sure that he couldn't take more than one sample, which programmed his mind to help him resist taking more. With my invention, this “new superego influence” is created by establishing a commitment to a “chain of promises,” so that once the individual adds a promise to his chain, he will feel sure that he will keep it with a high degree of reliability. Then, whenever he adds a promise to his chain, he will be able to activate the Mental Shielding capability of his mind with a high degree of reliability, which will program his mind to help him keep his promises. (Yes, it's a circle: one must create a “mental sureness” that he will follow the behavior that he wants to program his mind to help him follow, as my invention accomplishes.)

This will enable him to activate this sure state of mind “at will” (whenever he adds a promise to his chain, as long as he is committed to keeping his promises), even in personal situations. The over-eater will be able to program his mind to help him resist temptations in his own home or wherever he is; so that he can easily, comfortably and reliably resist them without having to fight his mind! My invention takes this up a step further: not only will the over-eater not have to fight his powerful mind to keep his promises—but he will have all that power programmed to help him keep his promises!

Of course, proving a mental state of sureness can be difficult. This invention does not attempt to prove this; but, rather, to teach, assist and motivate people in achieving and maintaining a high level of sureness regarding keeping the promises they add to their chain of promises. The Shield Method helps people establish their chain of promises and make a strong commitment to keeping the promises they add to it. Then it teaches them techniques for using the resulting reliable control.

It's important to note that commitments are a normal part of life. People easily and naturally make commitments throughout their lifetime. They just decide that they want the benefits of something that requires a commitment enough to make the commitment. Commitments are easily and comfortably maintained, as long as the behavior is easy enough to follow and the benefits to them are sufficient to maintain them. Examples include the commitment to a spouse, to maintain the relationship; the commitment to drive in the legally designated lane, to avoid getting in auto accidents; and even simple commitments, such as always adding detergent to loads of wash, to make sure the clothes get clean.

To help people make a very strong commitment to keeping the promises they add to their chains, so that they can reliably achieve the sureness required to program their minds to help them keep them, we use any or all of the methods listed in the steps of this application (see #7 of “Outline of Lessons”).

A chain makes all the difference! Without the chain of this invention, there are not sufficient consequences to create the required sureness to program the mind. If the over-eater does one bad thing regarding his diet, it's just one misdeed that he can easily rationalize that he can make up for “tomorrow.” For example, when tempted to break his diet today, he can simply tell himself that he will make up for it by fasting tomorrow. Therefore, he can always rationalize that there will be no consequences whatsoever! And every “tomorrow” he can make another “procrastination rationalization”! But by linking every promise to a chain that gives him easy, comfortable, reliable personal control—and won't give him these benefits if he does not keep his promises consistently—now that's a sufficient consequence to help him remain sure that he must keep his promises consistently!

The Shield Method works because: (1) the rules provided make it very easy for the Shielder to keep the promises he adds to his chain (he's even excused for forgetting to keep them!); (2) The Shielder highly values the personal control that results from being to program his mind to help him keep his promises; and (3) The consequence of losing this precious control is strong enough to keep him comfortably committed to keeping his promises. (This is more thoroughly described in Fig. B. “The Locking Mechanism.)

The chain of promises has a doable, lasting quality that can finally make it possible for people to succeed at weight loss! (All participants of the test group said that they could easily maintain their control indefinitely—even those who gave up previously on diet after diet. This is a significant improvement!)

I have found that the possibility to have an “id” desire must be completely eliminated in a person's mind for their ego to be able to form and maintain a reliable Mental Shield. This is why it was never possible to activate the “Shielding” ability of the mind for weight loss (and other personal control applications) before. How could the possibility to have excess food be eliminated, when food is everywhere around us or so easily obtainable in today's society? My invention is the first that eliminates the real possibility to have desires in the person's mind, which is the way many Mental Shields work. For the first time, this Mental Shielding ability can enable people to comfortably and successfully “pass up” short-term desires (like tempting foods) so that they can achieve their long-term desires (like weight loss).

Note: There has been some confusion about the “absolute sureness” spoken of above (and in the original application). This happens at the moment a person “decides” to keep (or go ahead with the behavior of) his promise. It does not mean that the individual is always sure that he will keep every promise, any more than most people are always sure that they will go to work every day. With a strong commitment to keeping his promises, the individual will usually feel sure that he will keep them; but his sureness can occasionally waver and may only become absolute seconds before deciding to keep a promise. (Decisions can activate Mental Shields, although it takes sufficient consequences to maintain them.) It's natural and healthy to occasionally “flirt” with ideas of doing other than what we feel we should do, to weigh the consequences. But once the Shielder becomes “sure” that he has too much to lose to break his chain, and decides to keep the promise, his mind will be programmed to assist with the behavior of the promise rather than fight it, since sureness programs the mind.

Once an individual is fully committed to keeping the promises he adds to his chain, he has achieved the primary Shield Method goal and benefit of reliable personal control. Then he is taught the “promise techniques,” for using the leverage of this reliable control to make effective promises that can help him achieve his goals.

Many of these techniques are specifically aimed at reversing the activities of the primitive id division of the mind. A number of techniques to accomplish this involve making promises to “delay quantity.” This acts in direct opposition to id urges for immediate quantity (instant gratification). With one such technique, the individual promises to eat half of his usual portion and then wait 15 minutes before eating more. This is an effective technique since it stops the “hand-to-mouth” reflex and allows time for the food he eats to register feelings of fullness and satisfaction. A second part of this technique is to get busy doing other things (rather than sitting and watching the clock) during the 15 minutes. This helps trick the mind into feeling that he is done eating. If he still wants more after the 15 minutes, a technique is to promise to have “just a little more” for another 15 minutes. (Many of these techniques are listed in the detailed description of this application.)

It should be noted that keeping the promises of these techniques will only be easy and comfortable when a person has a strong commitment to his chain of promises, so that his mind is programmed to help him keep them. Otherwise, his powerful primitive mind can fight his promises, making it extremely difficult and unpleasant to keep them! (Trying to eat just one cracker can be difficult and feel like unbearable deprivation to the over eater, unless his mind is programmed for this behavior, as my invention accomplishes.)

Having made a strong commitment to keeping the promises he adds to his chains makes the Shielder's chain as unbreakable as other “chains of behaviors” that he is committed to, such as: to cover all of the checks he writes without intentional exceptions; to make every house payment without intentional exceptions; and to add detergent to every load of wash without intentional exceptions. This gives him reliable personal control any time he adds a promise to his chain—even in personal situations that he could not reliably control before.
When fat Albert is sitting in his living room and has a desire for some pie in his kitchen, he can now add a promise to his chain, such as to have only one small piece for three hours. And since he is sure-committed to keeping his chain of promises, this will program his mind to help him feel comfortable with just that much. Should he want more after the three hours, he is completely free to have it—relieving all pressure! But he always has the ability to add promises to his chain—and knows powerful promise techniques to use to reverse the impulses of his primitive mind—to help him easily and comfortably stay in control. His self esteem from his ability to reliably control his behaviors—and from the resulting weight loss—will naturally soar!
Each promise Albert makes “locks-in” better behavior. Any promise to do better is an improvement. Making a lot of little improvement promises can quickly add up to real progress towards his weight goal. (The Shield Method gives many ideas for making very easy, yet very effective promises for reliable and consistent progress towards his weight goal.) He can make promises for any eating improvements that he can think of—the possibilities are nearly limitless!

### Second Embodiment

Part of the first embodiment of the present invention includes a business method for teaching the Shield Method and providing support. The second embodiment, as described later in this application, provides a software program used in a device (such as an iPhone). All of the teaching and support methods of the original application are easily provided in such a device, with additional features which enhance it considerably, as described in the detailed description.

Some additional objects and advantages of this method are:
a. It can decrease the number and severity of temptations and urges to do other than a person's specifically planned behavior intentions.
b. In addition to enabling people to withstand strong temptations and urges to do other than their specifically planned behavior intentions, it can make it easier for them to resist mild to moderate temptations and urges to do so.
c. It can significantly reduce the need to expend energies required to maintain willpower.
d. It can make people much more comfortable while performing specifically planned behaviors intentions.
e. It can significantly increase people's ability to control their behaviors.
f. It can significantly increase people's confidence in their ability to control their behaviors and achieve their goals.
g. It can significantly increase people's self esteem and sense of accomplishment.
h. It can make it easier for people to resist strong temptations and urges to do other than their specifically planned behavior intentions.
i. It can be relied upon to work almost any time and any place.
j. It can deflect urges and temptations to do other than a person's specifically planned behavior intentions (so that they are decreased or eliminated).
k. It can enable people to be able to quickly regain control if they start to lose it, such as when a binge begins.
l. It can improve habits, even permanently. I believe this invention is the first method to date that can help a majority of people easily and quickly establish new habits, and it may be the first true cure for “Binge Eating Disorder” (B.E.D.). It can significantly increase an individual's ability to succeed at personal goals, while also significantly decreasing their levels of stress.
m. It can help establish new “better” habits that are preferred over old “bad” habits. Many methods attempt to teach better behaviors, but these may not be preferred!
n. It can improve health (by helping people achieve goals in areas of weight loss, exercise, control of alcohol consumption, etc.).
o. It can be used to control almost any behavior (“do” behaviors, such as “do exercise” as well as “don't” behaviors, such as “don't” eat a second helping).
p. It provides a method for obtaining personal goals that not only reduces stress, but is as enjoyable, exhilarating and fun as a game. This enables people to be able to stay on it indefinitely for consistent progress.
q. It can often eliminate the need for risky, invasive methods of personal control.
r. It significantly reduces major setbacks in progress.
s. It can enable many weight loss programs that have not worked to work now.
t. The preferred method of delivery also provides personal analysis, teaching, training, guidance, support, motivation and new applications for use of the Shield Method.
u. This invention provides a method that overcomes at least 2 major problem of the prior art, by providing a means for self control that is capable of withstanding strong urges and desires to do other than a person's specifically planned behaviors and achieving a high degree of success in keeping them. Therefore, it provides an improved method of achieving personal control.
v. The individual does not have to be deprived of the foods he loves—he can enjoy less (like the over-eater at the sample table) and stay in control!

Further objects and advantages of my invention will become apparent from a consideration of the flowcharts and ensuing description.

### BRIEF DESCRIPTION OF THE DRAWINGS

Figure A. This is a flowchart of the steps involved in helping people learn and use the Shield Method and of providing support and unique business and promotion the Methods.

Figure B. This is a diagram of the “locking” mechanism, or how Mental Shields become more and more reliable.

Figure C is a flowchart illustrating the promises tracking method according to the preferred embodiment of the present invention.

Figure D is a block diagram illustrating the promises tracking device according to the preferred embodiment of the present invention.

Figure E illustrates a user interface of the personal control scores display on a screen according to the preferred embodiment of the present invention.

Figure F illustrates a user interface of the test scores display on a screen according to the preferred embodiment of the present invention.

Figure G illustrates a user interface of the promise scores display on a screen according to the preferred embodiment of the present invention.

Figure H illustrates a user interface of the assignment scores on a screen according to the preferred embodiment of the present invention.

Figure I illustrates a symbol for levels and categories according to the preferred embodiment of the present invention.

Figure J illustrates a Sureness Temperature Display on a screen according to the preferred embodiment of the present invention.

Figure K illustrates two buttons displayed on the screen for selection according to the preferred embodiment of the present invention, illustrating the two buttons as an “excused broken promise” button and an “unexcused broken promise” button.

FIG. 1 illustrates the screen on a smart phone according to the preferred embodiment of the present invention, illustrating the three touch buttons as “a time setter”, an “excused broken promise” button and an “unexcused broken promise” button.

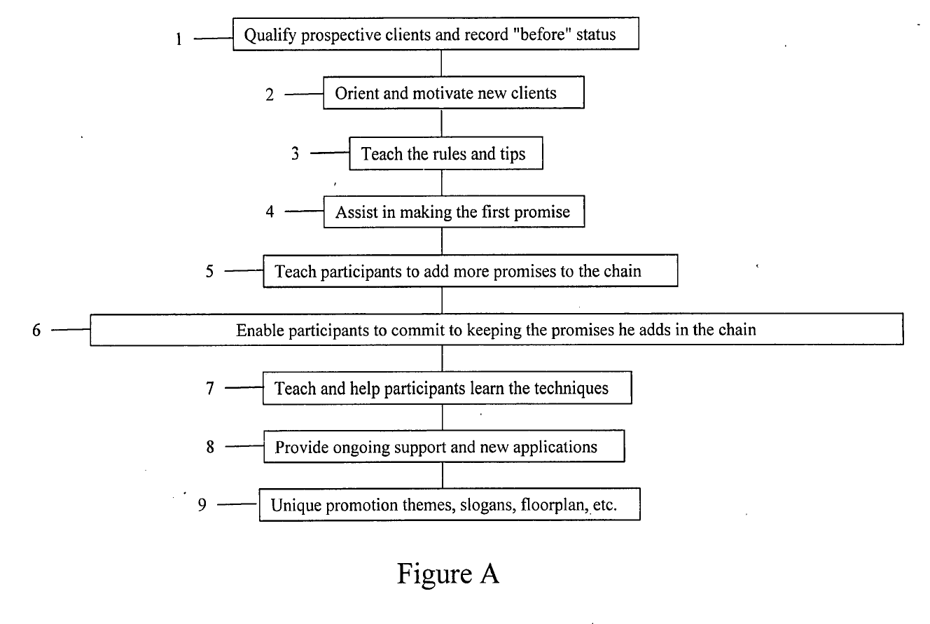

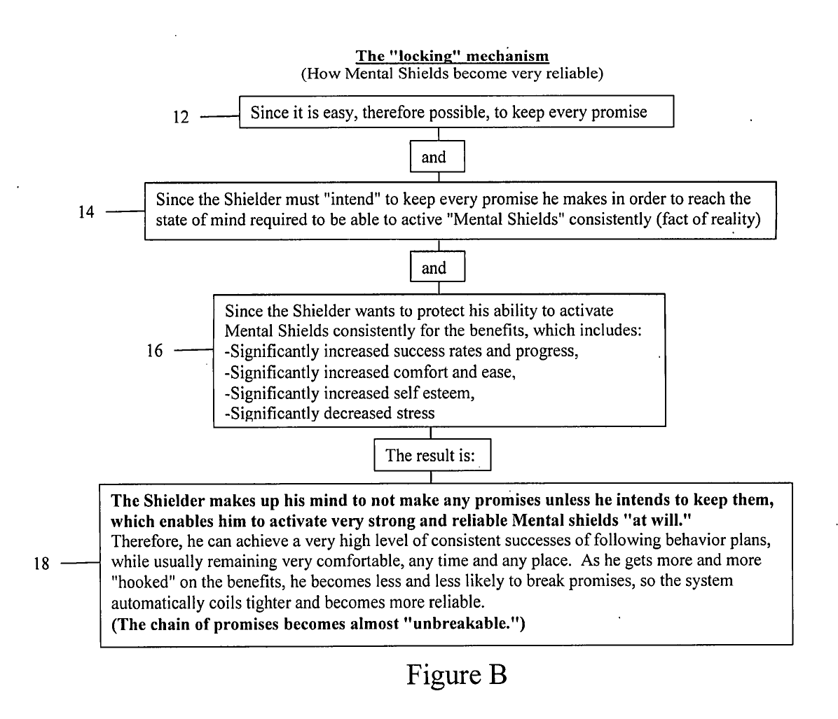

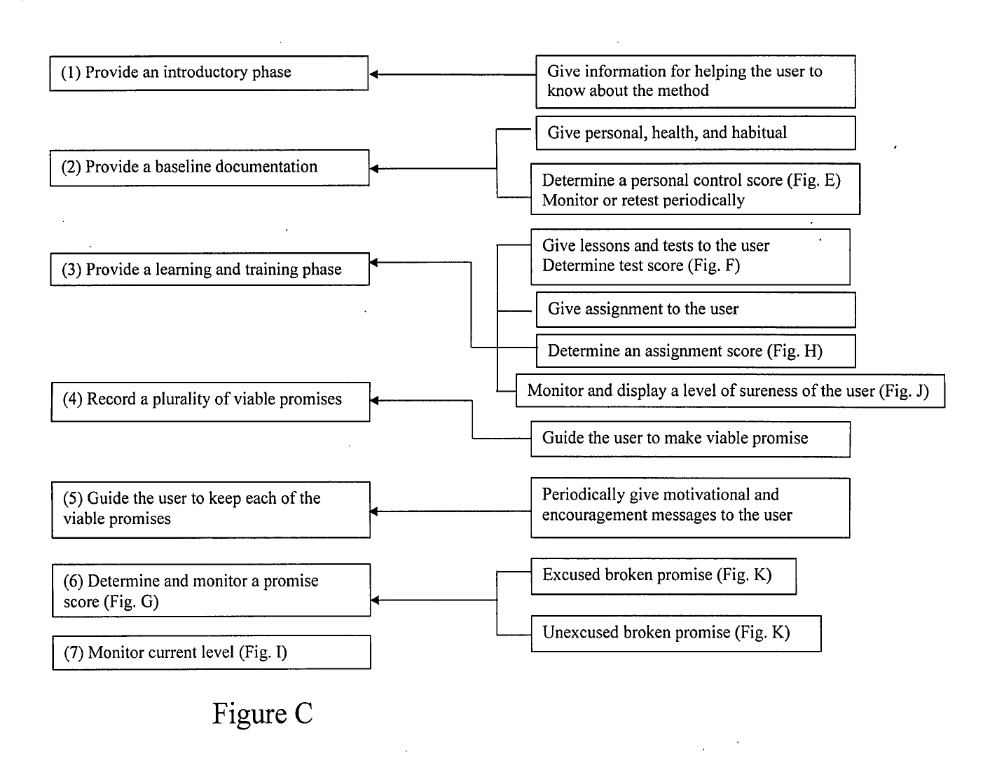

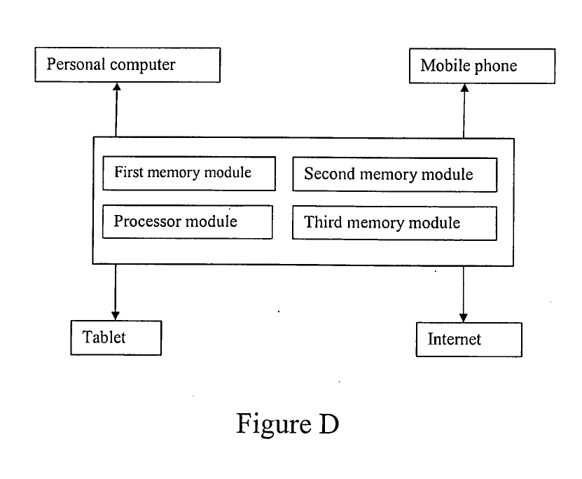

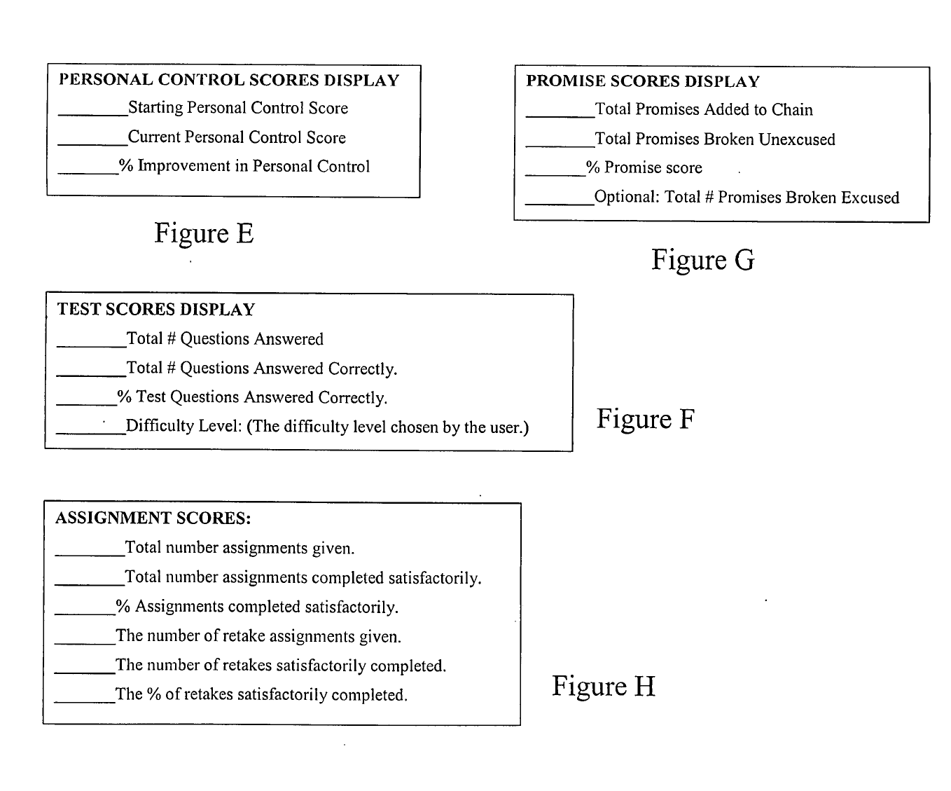

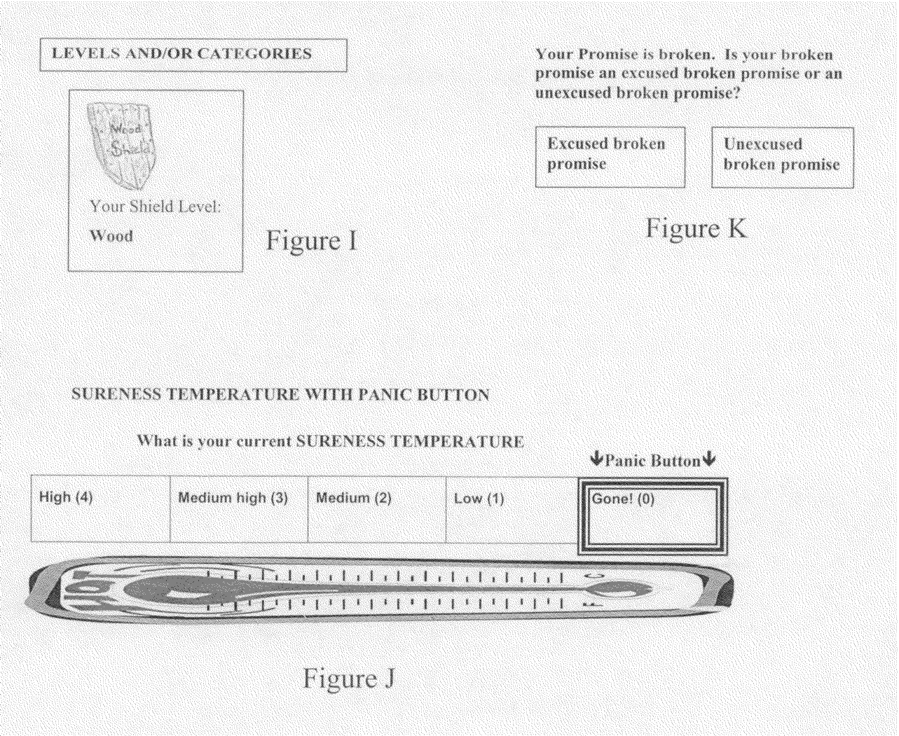

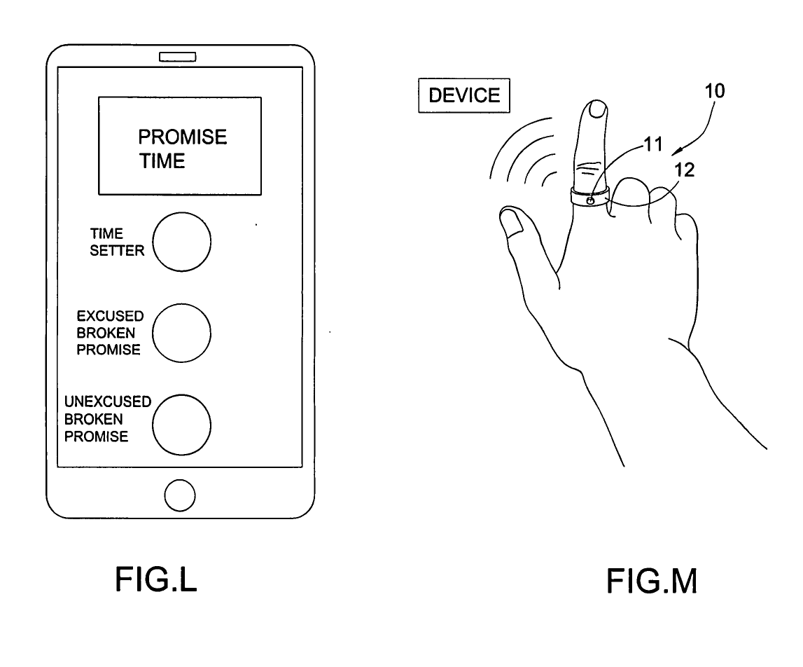

Figure M illustrates a ring shaped activator for generating physical activation signal according to the preferred embodiment of the present invention.

### DETAILED DESCRIPTION OF THE PREFERRED EMBODIMENT

The following description is a preferred embodiment for weight control, although the method may also be used for almost any other personal control applications as well, with or without modifications. Without being taught any modifications, Shielders often automatically use this method of activating Mental Shields to control other personal behaviors, such as to stop smoking, control drug and alcohol consumption, follow exercise programs, etc. Many more alternative uses are listed in the “Conclusions, Ramifications and Scope.”

The preferred embodiment is to have the individual come into an office or clinic for appointments and learn through the use of lessons and support group meetings for the additional support that this format provides. However, the program could be taught in almost any other format: book, home-study course, computer program, video or audio tapes, seminar, etc. Support is highly recommended and could also be given in many other ways (by interactive computer program, telephone calls, scheduled messages, FAX, on-line support groups, meetings, computerized or manual support system, etc.).

The overall goal of this invention is to help people form, commit to and effectively use a chain (or succession) of behavior promises in such a way that they can activate the natural Mental Shielding ability of their minds for keeping the promises they add to their chain with a high degree of reliability. When this state of mind is activated, it can effectively program their mind to follow the behavior they have promised, altering activities of their mind and body to help them follow the behavior plan with a very high degree of reliability and success.

The steps of teaching people to create and use this chain of promises are outlined in Figure A. These steps are described below but are not required to be given in the exact order.

Figure A, #1: Qualify prospective clients and record “before” status. This is accomplished by collecting information about their current habits, current levels of control and motivation and goals. If they are found to be good candidates, payment arrangements are made. We may then complete a more detailed “before status” analysis (of current habits, goals, physical status, etc.) before proceeding to the next step.

Figure A. #2: Orient and motivate new clients. We teach new clients the Shield Method terminology, what Mental Shields are, more specifically, and the benefits that the Shield Method can offer them. We inform them of what to expect and what is required of them, regarding attendance, etc. A preferred embodiment is weekly individual learning and evaluation appointments followed by weekly support group meetings, as needed or desired. We verify that new clients understand essential information by testing or through the use of an interactive computerized format. The following is an example of an orientation description that we may provide:

What are Mental Shields? A Mental Shield is a programmed state of mind, which is acting to protect a person, plan, behavior or belief. Mental Shields are activated by the mind whenever we feel “absolutely sure” that we can't (or won't) have something that we might desire. They make us comfortable without the things we feel we can't (or won't) have. For example, when we are in a restaurant waiting for a table and see food on a stranger's plate (who is currently eating it), we feel sure that we can't walk over and take the stranger's food—even if the food is very appealing and we are quite hungry. This is the mental state required to activate a Mental Shield, so we are “Shielded.”

When Shielded, our mind won't work to obtain that specific food on the stranger's plate (although it may inspire us to order the same thing). Rather, it will be programmed to help us remain comfortable while waiting to be seated and served. The mind is so good at this that it even makes us sort of “blind” to the stranger's food (we can see it but in a different, non-pursual way). This example illustrates the high success and comfort rates of Mental Shields. They are usually more than 99% effective at protecting behaviors while keeping us as comfortable as possible.

This is an example of a permanent “Social Shield,” not a “Personal Behavior Shield” (PBS) that the Shield Method teaches people to activate. When an over-eater is home, they're likely to eat anything and everything they want because they are not protected by a Behavior Shield at home.

The Shield Method enables people to activate very reliable, very strong Personal Behavior Shields “at will.” This can give them very comfortable and reliable personal control at home or anywhere else. This is why I named this method the “Shield Method,” because it “Shields” or protects people from the discomfort of having to fight their minds and the resulting failure, low self esteem, etc. It also protects their success in tempting situations!

Learning the Shield Method is like learning the rules and techniques of a game. The ordinary steps produce an utterly unexpected, extraordinary result. The individual follows the rules and they work instantly, without having to practice, although practicing the techniques of using them will increase their skill and ease of obtaining goals. In a preferred embodiment, Shielders learn by attending individual appointments and support-group meetings. Time is allowed between appointments for practice and to let the information sink in. The Shield Method can dramatically improve personal control and can be used to obtain many personal goals, such as weight loss and to exercise consistently without a personal trainer, etc.

Additional information about Mental Shields:

To orient the individual to the concept of “Mental Shielding,” scientific descriptions and examples may be given, such as those given in this application.

For example, “mental Shielding” may be described in the psychological terms of the id, the ego and the superego, the three divisions of the mind or “psyche.” The id is the primitive mind (instinctual drives). The superego represents the moral standards and ethics that you believe in. It rewards you with good feelings about yourself when you meet these standards, and makes you feel bad when you don't.

The ego mediates between the above 2 divisions of the mind. According to Taber's Encyclopedic Medical Dictionary, “The ego possesses consciousness and memory and serves to mediate between the primitive instinctual or animal drives (the id), internal social prohibitions (the superego), and reality. Thus the ego allows one to adapt to what might otherwise be a very unpleasant situation. The psychiatric use of the term should not be confused with its common usage in the sense of ‘self-love’ or ‘selfishness.”

To clarify, think of the above example of being in a restaurant: When you are very hungry and want to eat (a primitive id desire), but feel “absolutely sure” that you can't take a stranger's food (because of a strong social superego influence), your ego will form a Mental Shield to protect you from the id desire, so that it is very easy and comfortable for you to be able to resist the stranger's food. If the mind couldn't do this, we couldn't adapt when it is not possible to have things that we want, and this would be “very unpleasant,” as the above Tabor's definition describes.

The Shield Method enables people to create a new, very strong superego influence, so that they can activate the natural “Shielding” ability of their egos. Or it may be the ego activating a protective mechanism as it does whenever a person cannot have a desire. Regardless, whenever a person attains the required state of mind, we have noticed that a Mental Shield always forms, in keeping with the Scientific Method. (Except in neuroses, when instinctual drives are in conflict with those dictated by the superego.)

The action and benefit of Mental Shields are that they actually “reverse” the activity of the mind. They stop the mind from working “for” desires that we feel we can't have; and they put the mind to work to help us succeed at resisting them. As in the above example, when we feel that can't take food from a stranger's plate (even though we could), a protective Mental Shield will be activated. Then our mind will not work to send ideas, thoughts, plans, rationalizations, etc. into our consciousness of taking the other person's food. Instead, it will do everything in its power to suppress these thoughts and help make us comfortable without the other person's food. It's so good at this that it is as if we are “blind” to the other person's food, in a pursual way. The actions of the mind to help us comfortably succeed can be mental, neuronal, chemical, physical and/or biological. As Pavlov's experiments with dogs, and countless other experiments have since proved, our minds affect all of these systems.

Mental Shields can be nearly absolute and unwavering, such as a parents unwavering commitment to care for a child; or a person's unwavering commitment to turn lights off before leaving a room. I refer to these kinds of Mental Shields as “Permanent Mental Shields.” However, even these Shields can be broken under certain circumstances. For example, under extreme circumstances, almost anyone can be provoked to commit murder.

Mental Shields are perfectly safe because they utilize the way the mind naturally works. In fact, “Naturally Thin Eaters” have permanent Mental Shields which enable them stay thin comfortably and successfully. The only time an over-eater can experience what this is like is when they start a diet. Then, a temporary Mental Shield usually “materializes,” and helps them sail by the donuts and other tempting foods without even pursually “seeing” them. But Diet Shields are only temporary. Sooner or later they disintegrate, and the dieter starts feeling uncomfortable and stressed because the id portion of the mind starts working for their habitual food desires. There has never been a way for dieters to maintain the state of mind that makes it easy and effortless before.

We all have and use Mental Shields in many areas of our lives (Credit Shields, Morality Shields, Social Shields, Physical Shields, etc.). Mental Shields are what allow us to act in civilized ways, rather than primitive ways. They are how we can enjoy eating in social situations, like restaurants, without fighting over food like packs of wild animals; and how we can live together in peace. They create safeguards for advanced societies so that we can protect the things that are important to us. They enable us to reach worthwhile goals that require us to work hard and pass up instant gratification.

When a person is not Shielded from a desire and their mind is working for it, we say that they are “Shielded for” the desire. When Shielded for a desire, a person may not listen to reason, because their mind will exaggerate the positive aspects of the desire and try to block out or selectively ignore the negatives. Sometimes only after the person obtains the desire will they be released from the Shield and able to clearly see the negative aspects of having the desire. As the saying goes, “Be careful what you wish for because you may get it and then realized you don't really want it.”

Mental Shields give incredible advantages and should be highly valued and protected because they allow us to surely and easily resist primitive desires. For example, a person with an Honesty Shield in a specific situation will be able to effortlessly return a wallet full of money that they find. It can be mentally painful and even impossible for a person without an Honesty Shield for the same situation to resist the desire to keep the money. We all have a “Shield threshold” in the amount of pressure our Mental Shields can take. For example, under certain circumstances, almost any one's Morality Shield can be strained to the breaking point and they will commit murder (called “breaking” a Shield). Shields can be permanent or temporary.

We have not been able to create the state of mind required to activate Personal Shields “at will” before. We have had to live with whatever Personal Shields our parents or life experiences gave us. The prior art describes that it is very difficult to change the contents of our superego so that we can permanently change habits. The Shield Method finally gives us a way to activate Mental Shields “at will” and even help to develop new permanent Mental Shields that we may desire.

Figure A, #3: Teach the rules and tips. In this step, we prepare the person to form their chain of promises by teaching them the rules for making promises:

### Rules and Tips for Adding Behavior Promises to the Chain:

1. Promises must be easy, safe and short-term (from less than 1 minute to no more than 6 hours in the beginning). This is to make it easy for Shielders to keep their promises.
   a) The individual is instructed in how to make promises that are “easy” for him to keep. This is no different than developing many other kinds of skills, such as ice skating. A new skater doesn't recklessly push himself onto the ice. He starts out cautiously, getting a feel for the ice, and stays within his level of ability. Similarly, the device user is told to make promises that will be extremely easy for him to keep, at first; and is given suggestions for making easy promises, such as promising to only have half of a roll for 30 minutes. As the ice skater uses feedback from his experience, and has a healthy “fear” of overdoing it, so does the Shielder, who gets a feel for making promises, and knows that he could “ruin his Promise Score,” or even fail if he overdoes it. This helps him stay within his level of comfort, in the same way.
   b) Examples of very easy, yet effective—and even fun—promises to use until he gains greater skill and confidence are provided, such as promises to “lock in” his intentions. If he only intends to have one small piece of pie, we encourage him to add a promise to his chain to only have that much for a certain amount of time, rather than leaving himself vulnerable to another piece right afterwards! He learns the “3 more bites” technique (when he can't stop eating from a bag of chips, for example, he can make a promise to stop after 3 more bites—and it's legal to pick out the 3 biggest chips!).
   c) He may be encouraged to try to make a certain number of promises per day, such as 12 (which can easily be done by making three promises at every meal and three between meals). This can cut hundreds of calories a day—and Shielders are thrilled with their easy, comfortable control!
   d) We encourage the “Shielder” to start at his own level. He may be told the following: “For some of you, it will be easy to make advanced promises, such as to have no fries with your sandwich. You've just lacked the control! (But why not Shield to have a few fries, if you really want them—bet you can eat just one!) Some new Shielders will not be able to make such advanced promises—yet. Don't worry. Just make promises on your own level, or those that are comfortable for you. Maybe you can promise to have half of the fries. Or perhaps you can promise to have a better choice, such as a salad. If you can't make any of these promises, simply toss a few fries in the trash and promise not to get them back out! Get the idea? Making promises at your own level makes it easy for anyone to make at least 12 promises a day! You may notice that sometimes you will feel stronger than at other times, and you will be able to lock in better promises during those times. As you become more comfortable making and keeping promises, it will automatically become easier to make more difficult ones.”
   e) Other techniques for making easy promises are provided. For example, he is taught that reducing the term of a promise will make it easier to keep. Promising to have a small portion of something for 15 minutes is much easier than promising a small portion for 6 hours—and short-term promises actually work better, since the primitive mind doesn't put up as much resistance to making them, yet they effectively stop the hand-to-mouth reflex and give food time to register feelings of fullness and satisfaction! Add to this a promise that he must not sit and watch the clock for those minute, but must get busy doing non-eating things, and he may forget to have more. If he still wants more, we encourage him to have it—although we ask him to consider having just one or two more bites. This is often all he needs!
2. A rule stipulates that the promise he adds must be short-term (usually less than 6 hours). It is explained that promises have a length of time assigned to them, but they don't have to have an exact time. For example, if he is standing at a checkout counter at a grocery store, he can promise not to eat anything from his grocery bags until he gets home and puts the food away. We've found that short-term promises can be the most effective promises since they are easier to make, yet they stop the hand-to-mouth reflex and make it easy to stop eating. Note: Longer-term promises may be allowed for certain behaviors, such as promising to attend appointments, etc.
3. A rule to only make promises to do “better.” For example, Shielders can't make promises to eat more than they usually eat.
4. Shielders can make promises at any time, more than one promises at a time, extend promises, make overlapping promises and can upgrade promises. (An example of an upgraded promise is promising to have no more than 3 cookies for an hour, and then upgrading the food to something more healthy of equal or lesser value, like 1 apple instead.)
5. Shielders are completely free to have more food after keeping their promises, unless an extended or overlapping promise is in effect. For example, if a Shielder promises not to eat anything for an hour, after the hour is over they are completely free to have more food if they want, unless another promise is in effect. This is important because it relieves all pressure (the individual only has to keep the current promise and he is completely free! Yet we have found that the techniques of the Shield Method are very effective in preventing Shielders from losing control after their promises are over; and they even reduce stress, since they know they can always use one of the promises techniques if they start to lose control.
6. A Shielder is not bound to keep any promise that is or becomes unsafe or unhealthy to keep.
7. A rule may state that “Shielders” can only make promises that they want to make. Note: The teaching and training process of the preferred in-office embodiment of the Shield Method is very effective in motivating most Shielders to make many promises consistently.
8. Shielders don't have to make any promise, but once they do, they are responsible to keep them. If they break any promise, they have to pay the following penalties.
   a) The immediate “rule” consequence of breaking a promise is loss of “Shielding privileges” for 24 hours (the forfeiture of the right to add any promises to their chain for 24 hours). The purpose of this rule is to give an immediate penalty and also to help the Shielder value the ability to use his Shield any time at will.
   b) The long-term consequence of habitually breaking promises is that they will lose all benefits of the Shield Method, since their ability to activate Mental Shields will deteriorate (as further described in Figure A, #6.)
9. Shielders are not held responsible if they “innocently” break a promise (such as when they forget they had made a promise), although they must take steps to remember their promises if it happens often (this doesn't happen to most Shielders very often).
10. When a Shielder is in the “act” of “innocently” breaking a promise, they do not have to stop instantly. We have found that the mind is so strong that you can't just stop eating a cookie that you forgot you had promises not to eat and spit it out immediately when you suddenly realize that you weren't supposed to have it. Few Mental Shields are so strong that they can withstand the full, infinite power of the mind instantaneously. The mind will “break” the Shield (make the person break the promise)! So we allow the Shielder to make a follow-up promise at times like this, such as “Just 1 or two more bites.” Without this rule, Shielders would unnecessarily and innocently break their chain of promises.

Step #3 may come before or after this point. For example, we may guide the individual to make their first promise(s) while learning the rules. The rules may be altered, according to what works best for each individual and each behavior goal. For example, it may be determined that a different length of promise is better for certain goals or custom penalties for breaking promises may be helpful for certain individuals.

Figure A, #4: Assist in making the first promise: To initiate their chain of promises, we usually “walk them through” making their first promise. A suitable promise for this is, “I promise not to eat anything for 15 minutes” (after asking them to start their chain at a time when they will not be eating). Alternately, we may instruct the individual to mentally decide on a first promise, in accordance with the above rules and any tips or suggestions that we have provided. We then instruct them to mentally make the promise.

Then we instruct participants to use a “physical activation signal,” to start their promise and seal it to their chain. For example, we tell them that after they decide on a promise to tap the thumb and middle finger of one hand together 3 times to “seal” the promise to their chain of promises. They are told that a promise is not added to their chain until they physically seal it to their chain in this manner. Once it is added to their chain, they are responsible to keep it or pay the consequences (described below). Using the physical activation signal is essential, since it starts each promise and helps to distinguish between promises they just “thought about making” and promise they have “actually made.” Any physical signal could be used, but this one works particularly well for most people. It can be used very discretely any time and any place to “seal” additional promises to the chain. After awhile, the signal may actually play a roll in activating Mental Shields, since it is often the moment that the person becomes “absolutely sure” that they will keep their promise. However, it does not, in itself, activate a Shield. Only the state of mind of being “sure” that a person will keep his promise can activate and sustain a Mental Shield.

Preferably, the present invention further comprises an activator 10, which is formed as a ring as shown in Fig. M, being worn by the user, wherein an activation button 11 is provided at a ring 12 worn by the user, such that when the user actuate the activation button 11, the physical activation signal will be generated.

By making his first promise, in this manner, the participant has initiated his chain of promises.

We tell him that his goal is to feel “sure” that he will keep all of the promises he adds to his chain so that his mind will be programmed to help him keep them. Otherwise his primitive mind will eventually begin to fight his promises, since they require that he pass up instant gratification. We explain that in order for beginners to achieve this sure state of mind, they just have to make up their minds to keep all of the promises they add to their chain, “no matter what.” We remind him that it is very easy to keep his promises and encourage him to keep his mind made up to keep his promise so that he can experience what it feels like to be “Shielded.”

Figure A, #5: Teach participants to add more promises to the chain. Now we instruct the individual to add more promises to his chain of behavior promises by following the rules and tips of making promises that we have given him. We may inform him that his “Shielding ability” is not yet reliable; and assure him that he will later learn how to make them very reliable. (The reason that it is helpful to have the new “Shielder” make unreliable Shields at first is that it helps him experience the benefits of Shielding so that he can value these benefits. This will enable him to complete the process of making his Shielding ability very reliable, as will be explained in Figure A, #6, below.)

Since the promises are easy and since participants are told to make up their minds to keep them, most Shielders can achieve the required sure state of mind to activate Mental Shields most of the time, even during this training process. We often encourage them to pay attention to the times in which they feel sure that they will keep a promise, because this is when a Mental Shield is in effect (their mind is programmed to help them keep the promise). We encourage them to notice the changes in how their minds work when they are “Shielded.”
a) The essential change is a very high success rate of keeping their promises, when they feel sure that they will keep them.
b) Other changes include feeling much more comfortable while resisting food desires that they have promised to resist which would ordinarily be difficult for them to resist; and
c) Much greater ease of resisting them.
d) Also, not having to fight their minds as much to resist them (fewer urges from their mind to have what they have promised not to have); and
e) Feelings associated with increased personal control, such as increased self esteem.

The rules that promises should be easy, short-term and voluntary were designed to decrease resistance from the primitive mind to making promises; and also to keep the individual comfortable. However, a person may not always be extremely comfortable keeping his promises, just like people are not always extremely comfortable keeping other Mentally Shielded behaviors (like paying every bill or feeding their families every day). Sometimes beginners count the minutes until a promise is over. But the programmed mind does practically guarantee success at following the behavior while making the person “as comfortable as possible.” The “boost” from the programmed mind usually makes them extremely comfortable.

Even if they do occasionally regret making a promise, they only have to “stick it out” for a short time, and then they are completely released, which is much easier than having to stick to a traditional diet for days, weeks, months or years!

We give incentives for beginners to make numerous promises, such as to experience what it feels like to be “Shielded,” and to make easy, fast progress towards their goals. Most are almost immediately delighted to find that they can now, suddenly, easily succeed at behaviors that they could not easily succeed at, or do at all, before. For example, they now have the control to eat less food, like half of a bag of chips or just one cookie, instead of a whole bag. They can also “seal in” their eating intentions and prevent foreseen eating disasters with promises, as we encourage in the techniques (Figure A #7). In this way, Shielders begin to enjoy the benefits of making easy, steady progress towards losing weight, by making promises to do just a “little” better than they usually do. We encourage them to notice and appreciate these benefits.

Some of the best promises for beginners are: make 3 promise to cut food at every meal; make 3 promises every day between meals; and use the following two-step technique: “First, cut more than you think you can; then decrease the term of your promise until it is easy to make the promise.” For example, promising to have half of a brownie for 3 hours may be a very difficult promise for a beginner to make. But, by decreasing the term to 30 or even 15 minutes, suddenly it's easy! And these promises can be very effective—especially if the Shielder adds to the promise to not to just sit and watch the clock, but to get busy doing other things for those 15-30 minutes.

Figure A, #6: Enable Shielders to form very reliable Mental Shields by teaching the “Locking Mechanism.” Up to this point, Shielders have been enjoying their ability to Shield, but the Mental Shields they are activating are not reliable. They are really only keeping their promises because they are easy to keep and because they “want” to. This is not enough! After the newness of this method wears off, their primitive mind will start working against their promises because they require them to pass up instant gratification (it will begin sending urges to have a second roll, for example, when they have promised to only have one).

Therefore, it is very important that they make a very strong and lasting commitment to keeping the promises they add to their chains, so that they can reach the state of mind required to activate Mental Shields when they add promises to it, with a high degree of reliability. We accomplish this by using any or all of the methods listed in the steps of this application (see #7 of “Outline of Lessons,” page 53). The most important of these (and most of the other methods contribute to it) is the “Locking Mechanism” concept, (Figure B. #12-#18—also page 60 in the “second embodiment”).

As diagrammed in Figure B, there are 3 components of the Locking Mechanism that enable the Shielder to achieve and maintain the sureness that he will keep the promises he adds to his chain with a high degree of reliability.
a. First, it is easy, and therefore “possible” to keep every promise (#12). Shielders are taught that it is not possible to “Shield” behaviors that are too difficult to follow. This is one reason why traditional diets break down. The complicated rules and restrictions of traditional diets are simply too difficult for most people to follow for very long. Urges for favorite foods and recipes—and to be free of restriction—can become as strong as urges for air! This is why their primitive mind works so hard to get people off of traditional diets. But Shielding is doable! The rules were designed to make it easy to keep every promise the Shielder makes every day for the rest of their life! The rules even excuse them for innocently breaking a promise or if it's unsafe to keep one.
b. Second, it is a true, unchangeable fact of reality that Shielders “must” intend to keep every promise to be able to activate Mental Shields consistently (#14). We teach Shielders that although they don't have to make any promises; once they do they can't even “intend” to break them. The reason is that if a Shielder allows himself to intend to break an occasional promise, then at every strong temptation he will have to ask himself, “Is this one of the promises I will allow myself to break?” Therefore, he can never feel sure that he will keep “any” promise. In other words, he can never rely on achieving the state of mind required to activate Mental Shields. He cannot have both exceptions in keeping his promises and personal control!
c. Third, because the Shielder learns to highly value and desire the benefits that he has never had before for personal control applications (of being able to significantly increase success rates at achieving goals with greatly enhanced comfort, ease, self esteem and decreased stress), he is motivated to protect this ability (#16).

As a result, Shielders can make up their minds not to make any promises unless they intend to keep them and therefore can enjoy all of the benefits of this system that they value (#18). As they get more and more “hooked” on the benefits, they become less and less likely to break promises. So the system automatically becomes stronger and more reliable.

Shielders are taught about “false” Mental Shields. With false Mental Shields, such as “Diet Mental Shields,” the person's mind will only help the follow the behavior as long as he wants and is motivated to follow it. As soon as it becomes unpleasant to follow and he no longer wants to follow it, his mind can “about face” and work against his diet! With “true” Mental Shields, the mind works to help the person follow the behavior even when it is difficult to.

A person who intends to break promises will eventually not be able to activate Mental Shields at all, per our observations, because his “Promise Shield” will be a “false” Shield. His mind will only work to help him keep his promises when it's easy to do and he wants to. It will be free to work against his promises when it's difficult to keep them. Since he won't have the advantages and success rates that true Mental Shields provide, he won't be any better off than before he started his chain (he will have to use willpower to keep his promises). Intending to break promises also welcomes unwanted desires into the conscious mind.

We may provide Shielders with analogies about similar “behavior chains” they already easily and comfortably maintain. For example, covering every check they write at a bank. If a person wants the benefits of having a checking account, they must be responsible to cover every check they write. In the same way, if they want the benefits of being able to activate Mental Shields, they must be responsible to keep the easy, short-term, voluntary promises that they make. Maintaining their chain of promises is no more stressful than their chain of bank checks. The rules even excuse them for making innocent mistakes (breaking a promise because they forgot), something that their bank doesn't allow! And it's important for them to “think twice” about their ability to keep a promise before making it, just as it's important to “think twice” about their ability to keep checks before writing them.

Of course, Shielders do occasionally break promises, but not usually intentionally. If they intentionally break a promise, they must pay the consequences dictated by the rules (Figure A, #3: Rule, #7) and also risk putting their ability to form Mental Shields in total jeopardy, as described in the “Locking Mechanism” (Figure B), which is the last thing most Shielders want to do. Most Shielders come to value the benefits so much that they don't want to be without them even for 24 hours, the rule penalty for breaking a promise (Figure A #3: Rule #7). Note: The above “locking mechanism” may be taught any time before or after this point.

Figure A, #7: Teach and help participants learn the techniques and tips. Here we teach the techniques that I developed to use with this Method, while continuing to monitor their progress and give support. We have found these techniques to be very effective in helping participants stay in control even when their promises are over. The techniques are numerous and, in a preferred embodiment, are taught during a series of multiple individual lessons as participants continue making promises and gaining skill. Some or all of these techniques may be taught before or after this point, as desired. This is a preferred embodiment for weight loss. With or without obvious changes, these can be altered for other types of behavior goals. Other related tips and suggestions may be given, such as health tips and ways of doing things that we have found work best.

Tips and Techniques for using Mental Shields for Weight Loss: During the weeks while learning to “Shield” and practicing, we teach the following tips and techniques: (The same techniques may be used for other types of behavior with or without alterations.)
1. During the training period, Shielders may be taught a technique for learning that they don't really want to eat without restriction, as they might think they do. This “Pig Out” technique is usually used with supervision. First we ask them to add a promise to their chain to eat less of something they usually “pig out” on for a short time (such as a promise to have just one cookie for 15 minutes instead of their usual 10). This enables them to experience eating much less in a sure (Shielded) state of mind. After waiting the 15 minutes, they are allowed to overeat or “pig out” as usual. We then ask them about the experience. Most Shielders soon learn that they wished they had stopped sooner.
2. A variation of this technique is to ask them to repeat the experience; but this time, rather than “pigging out” after their promise is over, we tell them to make a promise to have just a “little more” after their promise (like half of another cookie for 15 minutes). This is called the “Poquito Mas” promise. By repeating this technique, most Shielders soon learn that they have the power to stop where they want and that they actually prefer to eat less food when they “Shield” the behavior. Most Shielders are thrilled that they have the control to eat less and actually prefer less!
3. With the “Brake Shielding” promise, a Shielder promises to have a limited amount of something for a short period of time. Before or after the end of the promise, he makes another promise to have a little more for another period of time. This may be repeated as many times as desired. Like a big, heavy truck going down a steep grade, they are “applying brakes” to avoid going out of control.
4. The above 3 techniques are effective for “don't” behaviors, such as “don't” eat so much. These techniques can be used in reverse for “do” behaviors, such as “do” exercise:
   a) The “Delay Quantity” technique is reversed by asking the Shielder to promise to “do” a desirable behavior for a limited or short period of time to experience the behavior in the state of mind of being Shielded.
   b) The “Poquito Mas” promise is reversed to “do” a little bit of the desired behavior, rather than just stopping altogether.
   c) The “Brake Shielding” promise is reversed to promise to “do” a little of the desired behavior for limited or short intervals, like an overheated truck going a little way up a steep hill and then stopping to rest or cool down as needed, but able to make steady progress towards it's goal.
5. We encourage Shielders to “set their own stopping point,” rather than continuing to their old stopping point, which, in some cases, is when they literally, physically can't eat any more (a Physical Shield).
6. To stimulate desires to make promises, participants are often encouraged to pay attention to their behavior desires with the “What do you really want?” technique. For example, do they really want to eat the 18 cookies in the box they have just opened? Or would they rather protect themselves from too many with a promise?
7. One of the most important techniques is the “Try and Compare” technique. Shielders are often encouraged to try a behavior that is difficult for them by Shielding or promising to engage in the behavior for a short period of time, and to notice how much easier it is to accomplish in a “Shielded” state of mind. Then to compare their old behavior to the new experience. If they want to make the desirable behavior a habit, they are encouraged to make promises to repeat the new behavior until it becomes easy and automatic.
8. The Shield Method may pattern techniques after the behaviors of successful role models in areas in which they wish to change or improve. For weight loss, for example, techniques may be patterned after the way “Naturally Thin Eaters” eat. These successful role models eat only when they are hungry, only until they are just full and don't usually eat between meals. (Over-eaters, on the other hand, generally eat whether or not they are hungry, eat beyond being full and often eat between formal meals.)
9. The many “positive aspects” of following the naturally thin eater model may be pointed out to Shielders, such as being able to look forward to meals with a good appetite, rather than already being full; being able to eat anything they want at meals; being able to walk away from meals feeling good, rather than stuffed; being able to easily maintain a healthy weight; etc. The Naturally thin eater never has to feel uncomfortable, because they get to eat when they are hungry, and it is easy for the Shielder to emulate. They simply estimate when they will be hungry and make a promise to wait until then. Note: the positive aspects of eating this way cannot usually be achieved by over-eaters unless they are in the state of mind of being Shielded, like naturally thin eaters are.
10. Some Shielders prefer to “Free Shield,” just cutting quantities and frequencies of eating as desired. Beginners can easily cut hundreds to thousands of calories from their eating per day, just by Free Shielding. Every time they cut 3,500 calories, they can lose another pound, since a pound contains approximately 3,500 calories, although there are other important metabolic factors to consider.
11. Shielders are often taught to use the “Loving Parent” techniques, wherein they are encouraged to act as their own loving parent who controls what and when they eat. Parents want their children to enjoy food, but don't want them to eat too much or think about food all the time. Shielders are encouraged to make promises as responsibly as if they were their own guardians.
12. Similarly, Shielders may be taught techniques for Shielding their children by imposing sure parental limits. Children who only eat what and when a responsible parent feeds them are typically less obsessed with food. They can get their minds off of food for hours at a time and enjoy meals more than adults. The wrong thing to do is let children decide what and how much to eat and allow them to become obsessed over foods. Shielder parents may also be taught how to give their children the most valuable possessions of all—positive permanent Mental Shields.
13. “Family Rule” and “Buddy Plan” techniques may be taught. If family members, friends, co-workers, etc. can agree on a behavior plan, understanding and agreeing to the Shield Method concept that they cannot intend to break the behavior, this can Mentally Shield them. However, they should formulate rules for innocently broken promises to avoid unnecessarily breaking their Shields. An additional rule for this application may include having a meeting if a rule is ever broken to correct problems or impose new voluntary penalties that are sufficient to maintain the state of mind required to activate Shields.
14. The “How much can you cut for 5 minutes?” technique. We have found that it is almost always better (and more healthy) to decrease the term of a promise rather than to increase the quantity of eating (or quantity of other undesirable behavior). For example, it's better to promise “No more than one cookie for 5 minutes” rather than “A whole box of cookies and nothing else for 2 days.” But the id portion of the mind will resist making restriction promises. So Shielders are encouraged to mentally consider how much they can cut for just 5 minutes. If they feel they can cut down to 1 cookie, we ask them to consider increasing the amount of time of the promise. Can they promise just 1 cookie for 15 minutes? How about just 1 cookie for 30 minutes. Whatever amount of time they feel comfortable with; we encourage them to Shield or promise. In fact, it is best to Shield the first easy promise they can think of and then try to improve it, to prevent changing their mind. As they soon learn, promising 1 cookie for 5 minutes “fools” their mind so they can easily remain in control. Most Shielders quickly learn to stay in control and lose their “fear of food” with this (and other) techniques.
15. The above promise can be used in reverse for “do” behaviors, by using the “Do just 5 minutes” technique. For example, it is often too difficult for the beginning Shielder to promise to do an hour of exercise, but it is easy for almost anyone to promise to do just 5 minutes. We have found that getting started is half the battle. If Shielders promise just 5 minutes of a desirable “do” activity every day, they often get involved and do much more, especially with support. If 5 minutes is easy, we encourage them to consider whether or not they can promise to do 15 or 30. Or, before or while they are doing their exercise, they can “lock in” a promise to do 10 more minutes at any moment of strength.
16. A related technique is the “Jack-up” or “Ratchet up” promise. While keeping a promise, a Shielder may have a moment of strength that they can take advantage of to improve or “Jack up” their promise. (While keeping a promise to have two cookies, the Shielder may have a moment of strength to promise not to have the second cookie.) Just being able to control their eating behaviors makes Shielders feel stronger, so it is not unusual for them to have moments of strength to improve their promises.
17. The id portion of the mind will resist long-term promises, since it desires to keep pleasure possibilities open. However, it is much easier for the Shielder to promise not to eat for 5 or 6 hours if they can promise to have a little snack during the 5 or 6 hours in case they want it or get too hungry. With the “Security Blanket” promise, the Shielder simply makes a promise like, “No eating for 5 hours, except I can have a cup of yogurt if I want it.” This makes it easier to make longer-term promises.
18. This brings us to the “Productivity” promise. The Shielder is encouraged to Shield or promise activities other than eating.
19. Shielders are often encouraged to take advantage of “Automatic Shields” for desirable behavior whenever possible. For example, a person who lives in a house in which they have to climb 2 dozen steps to get to their front door is “Shielded” to do stair-stepping, without having to make promises. Since the person feels “absolutely sure” that they have to climb the stairs, their mind helps them accomplish the exercise easily and comfortably, without even thinking of it as a chore. Other Automatic Shields include not buying a car, so you have to walk everywhere, and having a dog who “expects” to be walked every day.
20. Just having the ability to Shield “at will” can “reverse the activity of the mind.” Whereas before, an over-eater's mind would always “flirt” with ideas of engaging in worse behavior, now their minds are always “flirting” with ideas of making promises to engage in better behaviors. Shielders are encouraged to enhance this reversed state of mind by using a technique of “Flirting” with ideas, plans, visualizations and rationalizations of how they could do better, not worse.
21. Shielders may be taught the “Stop the Hand-To-Mouth Reflex” technique. Interrupting the “hand-to-mouth” reflex of eating, even for a few minutes, seems to decrease urges to eat more by signaling the brain to stop eating.
22. One of the most effective and easy Shielders techniques is called the “Promise Too Much,” technique. Shielders promise not to have any more than they think is “too much.” For example, when a pizza arrives, the Shielder may think they “should” promise to only have 2 pieces, but their id makes them hesitate. Yet they think that 4 pieces would be way too much to have, and promising to have no more than 4 pieces would be an easy promise for them to make. We encourage them to make this easy promise immediately, to avoid eating even more than 4 pieces feeling so bad about their behavior that they just keep eating! This technique prevents Shielders from eating even more than they think is too much, and can be used as leverage to improve the promise at a moment of strength. We often find that once they make the promise to have no more than the amount they think is “too much,” the fact that the “danger” has been eliminated makes them feel so relaxed and confident that they can easily improve the promise. This is also called the “Eliminate the Danger” technique.
23. We have a technique that Shielders can use to gently reduce their appetites called the “Eat Down Your Appetite” technique, wherein Shielders have what they want but less. When promised consistently, this can reduce or eliminate low blood sugar or diabetes by actually decreasing the size of the Islets of Langerhans of the pancreas which produce insulin, according to the Guyton's Textbook of Medical Physiology. The person may no longer suffer symptoms of light-headedness, shakiness, fatigue or extreme hunger when they eat less, since their insulin response to eating will not overly deplete the blood of sugar.
24. Shielders are often encouraged to use the “Get Satisfied” promise. They learn that they can only truly get satisfied when they Shield a limited amount of food. Otherwise their mind will keep working for more and more food. Over eaters learn why they may have been eating without ever really getting satisfied and learn to enjoy “less food” more than “more.”
25. The “Have It Later” technique teaches Shielders that they don't have to have things they want immediately, and they don't have to deprive themselves of things they see and want when Shielded. They can buy or take things to enjoy later.
26. Shielders are often taught to take advantage of the protection that other kinds of Shields may give them. For example, the support group meeting utilizes strong “Social” and “Competition” Shields to help motivate Shielders. Not bringing especially tempting foods home can “physically” Shield a person while at home (however, most experienced Shielders can easily control their behavior at home, even with the strongest temptations in their kitchens).
27. Shielders are often taught the “Out of Sight, Out of Mind” promise. Putting away the food they have Shielded not to eat is a good policy to reduce forgetting that they promised not to have more and reduce temptations.
28. With the “Bite the Bullet” or “Just Make It” technique, Shielders are often encouraged to “just make” some promises that are difficult for them at a moment of strength for the purpose of experiencing new behaviors in the state of mind of being Shielded.
29. Shielders are often taught to “Shield their intentions” and “Shield their plans.”
30. The “Predict the Future” technique, is thinking ahead and making promises to prevent undesirable behaviors. When a Shielder thinks ahead, they can make promises to avoid behavior disasters.
31. One of my favorite techniques is the “3 more bites” promise because it works almost like magic. When a Shielder finds himself eating (like from a box of crackers) and can't seem to stop, he asks himself how many more crackers or “bites” he will allow himself to have and Shields it. This makes it easy for him to stop and helps the dragons of his mind prepare him to feel satisfied at the exact point he is Shielded to stop. Beginners usually can't promise to have just “3 more bites,” but they are encouraged to think of the lowest number of additional bites that they can comfortably promise. Even 10 more crackers are better than the whole box. Experienced Shielders can usually easily promise just 1 to 3 more.
32. There is one condition in which we may actually encourage Shielders to break promises and pay the consequences. That is when they are having trouble committing to keep their promises. When a Shielder has trouble committing to keep their promises, it usually means that the consequences of breaking promises are not strong enough to Shield them. They should not try to force themselves to keep their promises with willpower. Instead, we have them use the “Love It Or Lose It” technique, in which we actually encourage them to break one or more promises and pay the consequences, so that they can learn how important their ability to Shield really is to them. This is sort of like asking a person to stop paying their bills so that they can learn how important their credit is to them. Once they learn that they can't have reliable personal control if they aren't reliable about keeping their promises, they usually have no problem committing to keeping their promises.
33. A technique called “Stop the Mind Battles” is taught to help decrease or eliminate conflicts between what a Shielder feels he “should” do and what he “wants” to do. By making a promise, the behavior decision is made and this stops the mind battle over what to do. Even making a short-term promise can alleviate the discomfort of a mind battle. Mind battles only happen when a person is not “Shielded.”
34. One of the most important techniques is the technique to “Establish New Habits.” The steps for establishing a new habits are to decide on a habit goal; Shield to “try” the behavior in the state of mind of being Shielded (with the mind working for the behavior instead of working against it); Compare the new behavior experience to the old behavior; Shield the desirable behavior regularly, with support until it becomes easy, automatic and preferred; a final (optional) stage “proves” that the habit is firmly established, if the person is actually revolted by their old behavior or would never go back to it.
35. When teaching people how to “Shield,” we may use a technique of telling them a fictional story about “The Dragons of the Mind,” who form the most powerful team known to man for obtaining desires. In a symbolic way, this story clearly describes the nearly infinite power of the mind and why it is almost impossible for a person to succeed at a behavior goal when they have to try to fight the dragons of their mind. It explains what is required to activate Mental Shields and how these Shields can put the power of the mind to work “for” a person's plans, rather than “against” them. The main characters of this story are Id the dragon (who represents the primitive mind and commands a host of Dragon workers), Judge Ego the Shield Master (who rules for or against desires) and the Superego Jury. Humanoids sit in the Superego Jury box who look like the Shielder's parents, church officials and people they look up to. The Superego Jury makes the individual feel good when they do what they feel they should and makes them feel bad when they don't.) Id the dragon is primitive in that he works for an individual's current desires without distinguishing between whether or not they are good or bad for him. Id can put the full power of the mind to work for desires, even when they are not very strong, and even cause desires to be intensified. For the first time, the Shield Method gives people a way to control or “Shield” Id for personal applications and get their minds working for positive desires and goals.
36. We have a number of “Fun Shielding Techniques” such as the “Mini Smorgasbord” technique, in which the Shielder has a small amount of all the foods they want. For example, he can have ⅙th of donuts (instead of 6 donuts) for a variety. Note: only Shielded people have the control for this to be fun (only when they are in the “Shielded” state of mind of being “absolutely sure” that they won't have any more than they plan).
37. Shielders often automatically make their meals “special” in some way (set a place setting, use special plates, etc.), even though we don't require them to. This is difficult for people who have not gone through the program to understand, but can be easily explained by the following example: When a Shielder “Shields” to have only ½ cup of ice cream, so that they feel “absolutely sure” that they aren't going to have even one more bite for a few hours, they automatically find themselves carefully measuring the ice cream, putting it in a tulip glass with a fancy long spoon, setting it on a doily and planning to have it right when their favorite TV show starts. (Yes, they do lick the tulip glass, but they don't have even 1 more bite than they Shield!) Note: Years ago, scientists noticed that naturally thin eaters do things like this. They often set place settings before eating, wait until they sit down before starting to eat, arrange their food pleasantly, etc. The scientists theorized that if they could “train” over-eaters to imitate such behavior, they could change their habits. This “behavior modification” training does not work for most people (otherwise it would certainly be the treatment of choice for obesity). The scientists didn't realize is that it's difficult and even mentally painful for people to try to eat like this unless they are “Shielded,” like thin eaters are. Then the behavior is often an easy, natural result, as in the ice cream example, above.
38. Shielders may be taught the “Not hungry? Shield time!” technique, in which they ask themselves at any time “Am I hungry?” If not, they are encouraged to Shield not to eat for any amount of time that they can.
39. The “You Can Take It With You” technique is another fun technique, in which Shielders learn that they don't have to feel deprived. When they are Shielded and see a food they really want, like a pastry, they can take it and have it after their promise is over.
40. With the “Diluted drinking” technique, the Shielder learns to dilute caffeine and alcohol drinks to the extreme, turning 1 iced tea into 6, or 16 ounce glass of wine into 6 wine coolers. The Shield Method helps Shielders control alcohol consumption just as it helps them control their eating.
41. Shielders learn a technique called “Regulate Your Hunger.” It's always easy to estimate when they will be hungry after a promise is over and they can make a promise to wait until then. Shielders have the control to have a small snack to “tide them over” so that they can be hungry at any chosen time.
42. A fun technique or game, called “Spot The Shield” can be used to find out what Shields a person has. You can tell if a person has a Shield for a particular behavior by their habits and how their mind is working. For example, if you ask a person if they ever eat when they are not hungry and they respond “No” or “Not usually” the person is most likely a naturally thin eater and has a permanent “Healthy Eating Shield.” People who don't fight over food like wild animals in social situations have healthy “Permanent Social Shields” for this situation. A person who scowls when you bring up the idea of abusing drugs most likely has a healthy, desirable Permanent Shield against drug abuse. If a person isn't listening to reason, they are probably “Shielded for” a certain desire that their mind is suppressing the negative aspects and exaggerating the positive aspects of having. These “Spot The Shield” techniques may have important applications in fields such as criminal science and child rearing.

Many of the above techniques may sound familiar. This is because they are used extensively for other behavior applications, such as legal, financial, social etc. For example, when you write a contract to buy on an installment plan, you are using the “Brake Shielding” technique for “do” behaviors (technique #4c). However, to my knowledge there has never been a way to use these techniques effectively and practically for personal control applications before.

Many of these techniques have also been used for weight loss before, such as the “Predict the Future” technique of thinking ahead and taking action to prevent undesirable behaviors (technique #30). But there has been no reliable way to ensure success in following them. Now, when a Shielder Shields this behavior, he is practically guaranteed to follow it. Contracts (another form of promises) have been tried for weight control, but have had very low rates of success and it is not possible to make or upgrade contracts instantly, any time and any place, as Shielders can do.

Therefore, the Shield Method is the “missing ingredient” we have needed to make all of these (and many other) techniques effective. Trying to use these techniques without utilizing Mental Shields has been like it would be if we had to try to pay our bills if we didn't feel “absolutely sure” that we had to.

Figure A, #8: Provide ongoing support and new applications. As participants continue with the program, we continue to monitor them and provide support and motivation. Our primary objectives are to encourage them to set and work on goals, prevent them from forgetting what they have learned and help them use the Shield Method consistently to the point of reaching their goals and changing their habits. They may reach a point that they no longer need to “Shield” behaviors because they prefer their new habits. We have noticed in preliminary tests that when Shielders receive adequate support (such as weekly appointments or meeting), most stop being out of control, lose their fear of food, have increased self esteem, change their behaviors dramatically and quickly start to develop new habits that they prefer. Weight loss is a side effect of the control. Personal support seems to give the best results. With personal counseling or support group, it is not unusual for Shielders to be able to decrease their food intake by ⅓rd or ½ with little effort. Support is important because the id portion of the mind will soon begin to resist the idea of making promises. With support, we have noticed that Shielders continue making promises consistently until their new behavior becomes easy, automatic and preferred, at which time they may no longer need to make promises for certain behaviors. Inexpensive support group meetings are highly effective, but any other type of support (personal, non-personal, interactive computer or device, etc.) that can help to Shielders set goals, continue making promises, increase their skill and prevent them from forgetting what they have learned will increase their ability to succeed.

At the end of the teaching process, Shielders often can't believe how much they've changed in such a short time, and so easily and gently! Most can do better than before in almost any situation and can rapidly regain control any time they start going out of control. We have noticed that after awhile, the number of strong urges to binge or overeat may decrease considerably or almost completely stop. I believe this is due to the establishment of a new, permanent “Mental Control Shield.” The person feels “absolutely sure” that they can maintain control, so the ego portion of the mind forms a protective Mental Shield against many id desires, so that when the id sends a desire into the consciousness, the ego can deflect it. The id is persistent, but not foolish. It won't work for “impossible” desires, so it eventually stops sending so many desires.

New habit development is the greatest achievement of the Shield Method. I believe the Shield Method is the first program that really can change habits, dramatically, very quickly and permanently. No other previous method has been able to so easily, quickly and effectively promote new habit development. Most doctors and scientists now agree that establishing improved behavior habits is the only sure way for people to be able to lose weight and maintain their weight loss long-term. The fact that habits are preferred is a great bonus of the Shield Method, since preferred habits are more likely to last a lifetime!

We may encourage Shielders to enroll in other programs that we may offer, such as a substance abuse, exercise or relationship program (understanding and using Mental Shields can help with personal relationships), etc.

Figure A, #9: Unique promotional themes, slogans, floor plan, etc. Unique advertising and promotion are geared to orient and educate potential clients about the benefits of the Shield Method and to interest them in programs that may benefit them. The business method may also include ongoing research to find new and ways of utilizing Mental Shields and of providing programs.

A unique advertising and office decoration theme based on Shields and dragons, medieval or other, may be used. The dragon theme originates from a story that is told during the teaching process of the Shield Method, about imaginary dragons that live in the mind, to more easily teach complex concepts of how the mind works. We may utilize characters and elements of the story, in advertising and in other ways to develop strong associations, in the public mind, with the Shield Method.

In addition, due to the fact that the Shield Method gives most people much more “willpower” than they have ever had, we often use the term “Super Willpower” as a slogan on business cards, stationary, web site, teaching and other materials, etc. A unique aspect of the office floor plan is the use of conference rooms with conference tables (or other tables) for support group meetings whenever possible. This is different from traditional support-group meetings which are usually held in open classrooms or meeting rooms without conference tables.

Another unique business method may include “chanting answers” to help fix information in the mind of Shielders. For example, at a meeting the instructor may call out or chant like a drill sergeant, “What happens when you don't Shield to do something you don't have to do? The members may then reply in unison, “It isn't likely to get done!” These may be musical chants and may be used in exercise meetings.

### CONCLUSIONS, RAMIFICATIONS AND SCOPE

It was only a matter of time before someone invented a greatly needed method for activating and effectively using the natural “Mental Shielding” ability of the mind that can give people easy, comfortable personal control, as my method accomplishes! By enabling people to reliably and consistently program their minds to help them easily and comfortably resist temptations that would otherwise be very difficult and unpleasant for them to resist, my invention overcomes the major problems of the prior art. It can significantly increase success and self esteem, while decreasing stress, illnesses and deaths. It can even quickly and permanently improve preferences and habits! Therefore, the Shield Method is an important advancement which can dramatically reduce problems resulting from a lack of personal control.

None of the prior art proposes the idea of creating mental sureness as a method for programming the mind for enhanced behavioral control; or makes creating mental sureness the specific goal of a method; or suggests finding a way to use this natural ability that the mind uses to help people resist temptations; or talks about the incredible advantages that this can give. To my knowledge, there has never been an effective or practical means of enabling people to activate this ability of the mind for personal control applications “at will” before. Indeed, it was presumed to be impossible, which is why no-one ever tried! These concepts were never even discussed-except perhaps by the military, to prepare soldiers mentally for combat situations. I didn't set out to program the mind by creating mental sureness, either. When my invention created a mental sureness to keep our promises, we noticed that our minds were not fighting the behaviors of our promises. In fact, it was helping us keep them. This was a very useful, yet unexpected and unobvious result. Each of the medical doctors and psychologists who participated in the clinical trials also certified in writing (and also on video tape) that adding a promise to their chain did, indeed, “set” (or program) their minds to keep it, making behaviors that would have been difficult-such as eating much less and stopping after a promised limit-much more easy and comfortable to accomplish.

Even if someone had thought of the idea of programming the mind by creating mental sureness, how would they go about creating it? (Motor oil on food isn't practical!) In the military, months of intensive, secluded training are necessary and the programming is directed specifically towards, readiness for combat. My method is the first that create this sure mental state instantly, easily, reliably, comfortably, “at will,” any time or place for personal control applications.

In highly documented clinical trails, once reliable personal control was established, over-eaters automatically started to go through some very positive transformations. Feelings of depression and helplessness were naturally replaced by feelings of accomplishment and power! And, believe it or not, they actually began to prefer less food to their old excesses! This is a reversal of negative transformations that they descended through as they lost control over what and how much they ate!

Although the description above contains much specificity, these should not be construed as limiting the scope of the invention but as merely providing illustrations of some of the presently preferred embodiments of this invention. Many additional applications can help people utilize the benefits of the Shield Method. Some of these are listed, below:
a) Embodiments for substance abuse control, such as for smoking, alcohol or drug use could be similar to the weight control application of this specification. Steps could easily be modified so that the amount and frequency use of these substances would be reduced and eventually eliminated, if desired.
b) Embodiments for “do” behaviors, such as to exercise consistently or complete a project, would also be similar to the weight control application of this specification. The Shield Method is easily be modified so that the amount and frequency of these desired behaviors is increased.
c) Possibilities for child rearing applications are numerous. Overweigh children can learn the method to lose weight and/or gain more personal control. Parents can use the system to better understand their children and learn more effective ways to control them, and establish better behavior Shields in them.
d) Numerous embodiments are foreseen in the field of psychology. With modifications, Shield Method programs could help treat addictions and many psychological disorders, such as obsessive and/or compulsive disorders. The Shield Method can give people a way to control their behaviors and decrease the frequency and intensity of their repetitive or other undesirable behaviors. It can enable people to experience new behaviors in a more non-threatening and comfortable way so that they can more easily learn to prefer better behaviors and change their habits. The Shield Method significantly decreases stress while increasing control and feelings of self esteem, which are extremely important in the field of psychology.
e) Shield Method programs may benefit people in the teaching and people management fields. It can provide people more effective ways of understanding and controlling behaviors, stress, increasing ease of tasks, etc.
f) Shield Method programs could be used to increase group performance, such as to reach goals set by a company or group.
g) Relationship improvement (family, spouse, other).
h) The Shield Method can have very important uses in the field of criminal science. Offenders have never had a way to control their behaviors other than with willpower, which gives very low success rates. Shield Method programs could help people better understand the criminal mind, provide more effective ways of changing behaviors, etc.
i) Since the Shield Method can change habits permanently, many previous systems that weren't very effective may now be effective. For example, weight loss drugs or clinics which can take weight off more rapidly may now work, because people have changed their eating habits and won't regain the weight afterwards. This is supported by medical science. According to Guyton's Textbook of Medical Physiology, the body's fat stores are maintained like a bank account. After a person gains the weight, it is like they have a large balance. Then, they only have to pay the monthly maintenance fee in order to maintain the balance. In other words, an overweight person does not have to overeat to maintain their weight. Doctors now frown on quick weight-loss programs before, because habits weren't changed and patients were likely to gain the weight back as soon as they went back to their old eating habits. Shielders who change their habits may be expected to keep the weight off for good on one of these programs.
j) A camp or retreat which would teach the Shield Method and offer rapid weight loss and/or other beneficial services simultaneously (such as to teach health concepts and increase metabolic rates) would be ideal.
k) Computer programs, which can teach, test and/or motivate people in the use of the Method.
l) Computerized (or other) games or practice devices that help participants increase their skill at forming and using Mental Shields.
m) Computerized (or other) systems which can be used as a “physical activation signal,” remind participants of the promises they have made, when to make a promise, the rules, techniques, motivational or educational information.
n) The “ShieldMaster.” Any device (computerized or other) that can give behavior commands or choices that the person feels they must follow (like a slave must follow the instructions of a master, except voluntary) to result in the required state of mind to activate Mental Shields. This could be programmed custom for the individual's goals and would have the advantage that the person would not have to make promises. The rules and techniques could also be programmed in the machine. Imagine a future where the person sitting across from you at lunch is interrupted, not by a pager or cell phone, but a call command from his ShieldMaster, and have to get up and follow the command he is given!
o) Computerized (or other) device that can produce the “sureness” state of mind required to activate Mental Shields.
p) Alternative embodiments which enable longer and/or more difficult promises, such as for advanced Shielders.
q) The Shield Method may be used in reverse for “reverse psychology” applications, such as to have a person experience a negative behavior with which to compare a positive one. This application is foreseen to be useful for people suffering from depression or to help people understand the negative aspects of behaviors whenever there may be a beneficial use.
r) The preferred “naturally thin eater” model is optional. Any other model of eating can be used in the embodiment for weight loss.
s) Models (as above) can be used for other embodiment uses for the Shield Method, as explained in the specification.
t) Many steps of the preferred embodiment of learning the Shield Method may be eliminated. For example, people can discover the benefits, uses and their lack of Shields without being specifically taught. Also, new permanent Mental Shields do not have to be established for positive results.
u) The Shield Method allows “new use” of all of the “prior art” techniques and uses listed in this application. When coupled with the method of this invention, they are suddenly much more functional, effective and give a dramatically different and improved result.

### Second Embodiment

Accordingly, a second embodiment of the present invention will be illustrated, using examples for the control of eating behaviors.

According to the second embodiment (Fig. C), the present invention provides a method of tracking promises from a user, which is a program operated by an electronic device (such as mobile phone, tablet, or personal computer) wherein the method comprises the following steps.
1) Provide a plurality of different phases for the user (Fig. C). The phases are an introductory phase, a baseline documentation phase, and a learning and training phase to the user. The introductory phase is arranged for introducing the tracking promises method of the present invention. The baseline documentation phase is arranged for evaluating what kind of lesson and assignment are given in learning and training phase. The learning and training phase is arranged for learning and training the promise techniques.
2) Record a plurality of viable promises made by the user in a chainlike manner to form a promise chain. The user is guide to make the promises after the learning and training phase.
3) Guide the user to keep each of the viable promises from the promise chain, wherein the user is enable to make the viable promise to endure situations that the user finds difficult, so as to guide for helping the user endure the difficult to keep the viable promises instead of fighting his or her efforts to do so.
4) Determine a promise score of the user regarding to the promise chain, which is an incentive to motivate the user to keep the promise score as high as possible, wherein when one of the viable promises is broken, the promise chain is then broken to have a negative affect on the promise score.
5) According to the second embodiment, the present invention further provides a device for tracking promises, wherein the device is preferably a program installed into the electronic device or being accessed through Internet. The device can be a hand held electronic device with a screen, such as a touch screen, wherein the program is pre-loaded in the hand held electronic device. The device comprises a plurality of memory modules and a processor module.
6) The first memory module stores different information of introductory phase, baseline documentation phase, and learning and training phase, wherein the different phases are displayed on a screen of the electronic device.
7) The second memory module stores the viable promises in the promise chain.
8) The third memory module stores guidance information for guiding the user to keep each of said viable promises from the promise chain, wherein the guidance information is arranged for enabling the user to make the viable promise to endure situations that the user finds difficult.
9) The processor module is arranged for determining the assignment score and the promise score. Accordingly, the user is able to selectively input the broken promise as one of the excused broken promise and the unexcused broken promise via an input means through the electronic device, such as keyboard or touch screen.
10) Promotional information about the App accomplishes the following:
   a) Helps the individual select the specific personal control App that he is interested in (such as for weight control, to stop smoking, control of alcohol, drug abuse, etc.) (Fig. A, #1);
   b) Motivates him, using a unique marketing method (see 13a, below);
   c) A free trial may be offered.
11) The individual purchases and installs the software (or downloads it).
   a) Alternatively, he may use it directly on-line.
12) Opening screens may include:
   a) Prompts to enter identifying information (his name, address, email address, etc.).
   b) A legal agreement to protect the rights and interests of the App provider.
      i) Approval may also be obtained in this agreement that information obtained from the user may be automatically (or manually) relayed back to the company that provides the software, via the internet, to help it improve the product; and for statistical and study purposes.
         (1) This approval may state that the individual's ID will be kept confidential, as per state and federal law.
      ii) The individual may have to check that he has read, understands and agrees to the agreement before being allowed to go on with the program.
   c) Information to help him determine if the program can help him (Fig. A, #1). The description will clearly state which individuals this program is likely to help. Since the purpose of the program is to increase self control, if the person's problem is due to other cause(s), the program may not help him.
      i) For the “eating control” App, this includes individuals who lack control of their eating behaviors which results in “over-eating” (eating too much and/or too often). They may or may not be overweight. If they are overweight but not from over-eating, they may be told that this program is not likely to help them and be advised to consult a doctor.
13) The program then enters the INTRODUCTORY and ORIENTATION PHASE (Fig. A, #2) in which information is provided about the purpose of the program, its benefits and an overview of how it works, as described in the Specification.
   a) This may be accomplished using the following unique marketing points:
      i) This App will enable you to master the “Shield Method” App for weight loss.
      ii) The Shield Method is the first method that can give people SUPER WILLPOWER for personal control. If you are an over-eater (you eat too much and/or too often), this program can give you SUPER WILLPOWER in eating situations, so you can easily slash hundreds to thousands of calories from your daily eating—without feeling deprived in the least. For the first time, weight loss can be easy and stress-free!”
      iii) Yet the Shield Method is more like a game than a cold, clinical method. You will simply establish a mental chain of easy promises that you won't break, “no matter what.”* Then, every time you add a promise to your chain, you will lock-in better behavior. (*Note: whenever “no matter what” is used in this context, it means “except when excused by the rules,” which are included in the steps below.)
      iv) But this powerful method is much more than just a game. It actually programs your mind to help you keep your promises! This is because it enables you to cross the threshold of SURENESS, which is required to program your mind. Once you are SURE that you will keep your promises, your mind will be programmed to help you keep them, resulting in super easy and super exhilarating personal control—your mind will be doing all the work! This is the same SURENESS that most people experience when they start a diet. They can sail by the donuts and other illegal foods with ease, because their mind is protecting or “Shielding” them from feelings of discomfort! But their SURENESS just doesn't last. With the Shield Method, it does!
   b) The App will then give an OVERVIEW of what the program will do for him:
      i) It will help him use the device and establish his chain;
      ii) Then it will teach him how to make amazingly clever promises (called the “Promise Techniques”) that will enable him to eat significantly less of regular foods—not diet foods—without even missing what he is cutting out.
      iii) It will guide and motivate him to succeed.
   c) Additional benefits of the app may be described. These include increased physical and mental health; reduction of stress and “mind battles” (battles in his mind over whether or not to do what he feels he “should” do); reduction of stimulations from the mind to do what he feels he “shouldn't” do; reduced feelings of restriction, deprivation, fear, guilt, and easy, comfortable, reliable personal control to achieve other kinds of personal goals, such as chores or exercise.
14) The program will then enter the BASELINE DOCUMENTATION PHASE in which “before” statuses are documented, prior to starting the learning phase of the program, to get baseline scores that can be improved upon (Fig. A, #1):
   a) He will be prompted to enter his CURRENT STATUSES into the program:
      i) His bodily statuses, such as height, weight and measurements.
      ii) His level of personal control in areas related to his goals (his ability to stop eating after having sensible portions, control quantities, etc.).
      iii) Other statuses related to his problem and/or goals (such as how his weight problem affects his emotional state or prevents him from participating in certain activities he's like to do).
      iv) The software will obtain these statuses by asking a series of questions pertaining to his current levels, in order to get baseline scores that can be improved upon. The software will group these by type of behavior, such as: “willpower”; “ability to stop eating”; “food choices”; “problems with quantity”: etc. The individual will select one of 9 options to describe his current status level: −4 (Never); −3 (Almost Never); −2 (Very Rarely); −1 (Rarely); 0 (Moderately); +1 (Often); +2 (Very Often); +3 (Almost Always); +4 (Always). An example of a question is: “How often can you set a sensible point to stop eating and feel satisfied and ready to stop at that exact point?”
         (1) The program will ask him to think carefully and select only one answer; truthfully, to the best of his knowledge. For example, if he selects −3, it means that his current level of control with this behavior is quite low.
            (a) If he accidentally selects more than one answer, the program will ask him to select just one. If he seems to be having trouble, there may be a “help” function or suggestions will pop up on the screen.
   b) After answering all the questions, the program will compute his “starting” STATUSES for all categories and store them in a chart as “Beginning Scores.”
      i) This chart will provide at least 3 comparison scores: starting score, current score, and overall improvement (the “current” and “overall” scores to be filled in later).
         (1) Every retest score may be listed for comparison.
         (2) Some or all scores of these scores may be displayed on the face of his device so that he can easily see them. For example, his PERSONAL CONTROL SCORE (see Fig. E).
         (3) He may have the option of displaying some or all of his scores on the face of other devices, such as his iPhone and/or iBook; or on a social-network program such as “Facebook” to announce to others how much or little control he started with and how these change as he advances through the program, for motivation to do well.
   c) He may be prompted to state the “primary problem(s)” that he wants to the program to help him solve (such as being overweight).
      i) He may be prompted to give a “case history” of this problem(s):
         (1) How long he has had this problem (how long he has been overweight).
         (2) Other methods or treatments he has tried: when, for how long and the results (for example, he tried a low carb diet for 6 months, lost 15 pounds but regained it over 6 months).
   d) He may be prompted to fill out a “symptom survey” of additional related problems that the program may be able to help him with (such as health problems, stress and self esteem problems).
   e) He may be prompted to list or select goal(s) (such as to lose a certain amount of weight, permanent weight loss, etc.).
      i) He may be asked to list or select reasons for why he wants to obtain these goal(s), (such as for improved appearance and health reasons).
   f) He may then be prompted to enter personal “Before” information (starting information about his health conditions, medications he may be taking, etc.).
   g) His current eating patterns may be documented: when he eats, how much, types of foods, etc.
15) The program will then enter the LEARNING AND TRAINING PHASE, which will teach the individual the Shield Method, using lessons, assignments and tests. (Fig A, #3-7)
   a) Lessons will be given by written format with illustrations and/or animations or other format. They teach how to use the device and how to establish and use the chain of promises.
   b) Each lesson will usually be followed by a test.
      i) Optionally, the lessons may be interactive, so that test questions are given as he takes them.
      ii) He will be informed that it is important to learn the lesson materials thoroughly.
         (1) To help motivate him to do so, he is told that his TEST SCORES will be displayed.
            (a) These scores will be recorded by the device on a chart and/or displayed as: total #questions answered; total # questions answered correctly; total number of questions he answered incorrectly; overall percentage of correct answers (Fig. F).
            (b) He may be told that his test scores are unalterable and permanent, to help motivate him to get the lowest number of incorrect answers and the highest overall score.
            (i) He may have the option of displaying his test scores or his overall test score on the face of his iPhone, on his iBook, or on a social-interactive program such as “Facebook,” etc. to show others how well he is doing on the tests, to further motivate him.
         (2) If it is determined from the individual's test answers that he has a serious misunderstanding that could impede his ability to improve one or more levels of control, he may not pass the test, then:
            (a) The program may prompt him to retake the lesson, review information or obtain help from a trouble shooter, online support group, counselor, etc.
            (b) He may not be allowed to proceed to the next lesson if he does not pass a test.
         (3) If it is determined from his answers that he has passed the test, then:
            (a) He will be allowed to proceed with the program.
         (4) The software will add his test scores to the chart and display(s) (Fig. F).
      iii) Proceeding with the program, assignments may be given between lessons, such as to make promises and practice techniques.
         (1) The program may require him to take a certain period of time for assignments.
         (2) A “Pre-test” may be given before his next lesson to determine if he completed the assignment and had the desired results.
            (a) If it is determined from his answers that he did not do the pre-test; or did have the correct answers or satisfactory result, he may not pass the pre-test. Then:
            (i) The importance of doing the assignment correctly will be re-stressed.
            (ii) He may be prompted to learn information more thoroughly by retaking one or more lessons or a part of a lesson; or to obtain help, such as from a trouble shooter within the program, online support group or counselor.
            (iii) He may be required to repeat the assignment until he gets the desired result, before being allowed to continue with the program.
            (b) If it is determined from his answers that he passed the pre-test (did the assignment and/or obtained the desired result), then:
            (i) He will be allowed to proceed to the next lesson.
            (ii) The software may add the pretest scores to the test scores (Fig. F).
            (c) The software will compute his assignment score and record it.
            (d) An “Assignment Score” may be displayed (Fig. H).
            (i) The “Assignment Score Display” may include:
            1. The number of assignments given.
            2. The number of assignments satisfactorily completed.
            3. The % of retakes satisfactorily completed.
            4. The number of retake assignments given.
            5. The number of retakes satisfactorily completed.
            6. The % of retakes satisfactorily completed.
   c) He will continue taking lessons and tests and doing assignments until he has completed them all.
   d) He will be able to make promises while taking the lessons and afterwards, indefinitely.
      i) A “Promise Score” will be calculated and displayed (Fig. G), below.
   e) Periodically, while learning the program and continuing indefinitely afterwards, the individual will be prompted to re-enter his statuses to document changes in his Personal Control Score (Fig. E).
      i) After re-answering the questions, the software will re-compute the totals and enter his new current status scores in the Personal Control Score Display and in the charts.
      ii) The software will compute and display the % improvement in the report and displays.
   f) The individual will be able to re-read lessons and re-take tests:
      i) The program may add the resulting tests scores to the Test Score Display (Fig. F).
   g) The individual may be able to re-do assignments:
      i) The program may add the resulting assignment scores to the Assignment Score Display (Fig. H).
   h) A “Panic Button” (in Fig. J) may be available on the screen for the person to press or access if he loses confidence in his personal control, such as if he is in a stressful situation.
      i) Pressing the panic button will result in lesson material, tips and/or suggestions to be provided to help restore his confidence.
         (1) The individual may be prompted to record or log the situation, the result and what he learned from it.
   i) A “Sureness Temperature Display” (Fig. J) may be available to monitor the individual's level of “sureness” that he will keep his promises (and/or eat half each time he eats).
      i) This may be steady on the screen or may appear daily, periodically or whenever there are indications that the individual's level of sureness is lowered.
      ii) The individual may be prompted to enter or tap his current level of sureness when prompted to, such as when the temperature display comes up on the screen.
      iii) If his level of sureness drops, lesson material, tips, logs and/or suggestions may be provided to help restore his sureness.
   j) He will be given an option to stop the session and finish answering the questions later.
   k) If he is interrupted from lessons, tests, etc., the program may remember where he left off when he restarts.
   l) Stories, examples and analogies may be used, throughout the program, to help him understand the concepts being taught.
      Outline of Lessons and Assignments: (Fig. A, #2-7)

The program helps the individual establish his chain and teaches effective Promise Techniques for adding promises to his chain for easy, comfortable, lasting personal control—using lessons, illustrations (which may be animated), assignments and testing.
1) It first informs the individual of the purpose and benefits of the program, as described in the Specification, with emphasis on the following: (Fig. A, #2)
   a) Information about the difference between following a behavior plan when his mind is FIGHTING the plan and when the mind is programmed to HELP him follow it.
      i) He is taught and given examples that demonstrate that if he has to FIGHT his mind to follow behaviors that his primitive mind would fight, it can be difficult and uncomfortable to try to follow them; and he will have unreliable success rates for doing so.
         (1) He is taught about the mind's powerful “mind-tools,” as described in the Specification, which can make it difficult and uncomfortable to follow his plans when he has to FIGHT his mind to try to follow them.
         (2) He is warned that, for the over-eater, trying to eat less may feel like “unbearable deprivation” unless his mind is programmed to help him do so!
      ii) He is taught and given examples that demonstrate that if his mind is programmed to HELP him follow behavior plans that his primitive mind would fight, it's easier and more comfortable to follow them; and he is more likely to succeed at doing so.
         (1) He is taught that his mind will use its powerful “mind-tools” to help him follow behaviors when it is programmed to help him follow them.
2) It explains the concept of the “chain of promises,” a central concept of the Shield Method.
   a) The purpose of the chain and its ability to give easier, more comfortable and more reliable personal control.
   b) The promises will be added to the program in a “chain-like” manner:
      i) Each promise will be added and numbered in the order that it was made.
         (1) Alternatively, the promises may be added by type of behavior in a chainlike manner.
      ii) If he breaks a promise, he is not just breaking the one promise but his entire chain, which will have a negative affect on his Promise Score (Fig. G) and may be irreversible.
         (1) This is a powerful incentive to motivate him to keep his score as high as possible.
3) The program walks him through making the first promise of his chain: (Fig A, #4) Note: whenever “promise” is used, below, it means “promise added to his chain of promises.”
   a) He may be asked to start his chain at a time when he won't be eating.
   b) He is directed (through explanation or illustration) to type or select a promise in the “Promise Entering” screen in the device.
      i) For his first promise, the user is usually prompted to type in or enter a specific promise, such as “I promise not to eat anything—for 15 minutes.”
      ii) A cursor may appear after “I promise,” to help him start each promise.
      iii) Alternatively, he may only have to select or fill in spaces to complete a promise, such as “I promise to only have ½ of a roll for 15 minutes.”
      iv) Each promise may require that an item, quantity and/or term be specified. For example, “I promise to only eat ½ (quantity); of a roll (item); for 15 minutes (term).
         (1) He may not be able to enter a promise unless it the required specifications.
   c) It is explained to him that he must push or tap an “enter” key (or “Add Promise to Chain” key) to add a promise to his chain.
      i) It is explained that once he adds a promise to his chain, he is responsible to keep it, “no matter what.”* (except when excused by the rules,” which are described below).
   d) He is directed to push the “enter” key.
      i) Once he pushes the enter key, the promise is designated as a viable promise on the screen with a number (1) next to it.
      ii) There may be an animated illustration showing that a link has been added to his chain.
   e) He is told that this has started his chain and is congratulated.
   f) Note: The device may be able to remember his promises so that once he begins typing them, the device will finish or partially finish typing it for him; and/or he may be able to select past promises; and/or there may be a menu of suggested promises for him to select from.
4) He is then taught the basic rules of making promises (Fig. A, #3) (These are also described in the detailed description of the first embodiment.)
   a) A rule that the promises he adds must be easy for him to keep.
      i) The individual is instructed in how to make promises that are “easy” for him to keep. This is no different than developing many other kinds of skills, such as ice skating. A new skater doesn't recklessly push himself out onto the ice. He starts out cautiously, getting a feel for the ice, and stays within his level of ability. Similarly, the device user is told to make promises that will be extremely easy for him to keep, at first; and is given suggestions for making easy promises, such as promising to only have half of a roll for 30 minutes. As the ice skater uses feedback from his experience, and has a healthy “fear” of overdoing it, so does the Shielder, who gets a feel for making promises, and knows that he could “ruin his Promise Score,” or even fail if he overdoes it. This helps him stay within his level of comfort.
         (1) Examples of very easy, yet fun and effective, promises to use until he gains greater skill and confidence are provided, such as promises to “lock in” his intentions; short “time out” promises (the same kind of “time outs” that are effective for controlling children); and the “3 more bites” technique (when he can't stop eating from a bag of chips, for example, he can make a promise to stop after 3 more bites).
         (2) Techniques for making easy promises are provided. For example, he is taught that reducing the term of a promise will make it easier to keep (promising not to have a second roll for 15 minutes is much easier than promising not to have another roll for 6 hours;
   b) A rule that the promise he adds must be short-term (usually less than 6 hours).
      i) It is explained that promises have a length of time assigned to them, but they don't have to have an exact time. For example, if he is standing at a checkout counter at a grocery store, he can promise not to eat anything from his grocery bags until he gets home and puts the food away.
         (1) Some promises may be longer, such as a promise not to have “any” or “any more” of a specific food.
   c) A rule that states that once he adds a promise to his chain he must keep it “no matter what.”*
      i) (*except when excused by other rules, as described herein.)
   d) A rule that he is completely free of the obligation of each promise after keeping it.
   e) A rule that excuses him from keeping any promise which is unsafe or unhealthy to keep.
   f) A rule that he may make more than one promise for the same time period; and promises can overlap. (He can make a new promise while he is keeping another or others.)
   g) A rule that he can upgrade or improve his promises. (If he has promised to only have two cookies, he can change the promise to just one cookie or no cookies.)
   h) A rule that he can increase the term of promises.
   i) A rule to only make promises to do better. For example can't make promises to eat more than usual.
      i) There may be exceptions to this, usually with doctor supervision.
   j) A rule that if he knowingly breaks a promise, the penalties are:
      i) He has broken his chain and his Promise Score is permanently marred.
      ii) He may lose all privileges of adding promises to his chain for 24 hours (or other term).
      iii) He is warned that he is putting his ability to program his mind to help him keep his promises in jeopardy, since he is teaching his mind not to take his promises seriously, which could cause him to permanently lose the ability to reliably program his mind.
   k) A rule that excuses him from being penalized for not keeping promises that he forgets to keep, on the grounds that he is “innocent.”
   l) A rule that states that if he is in the act of “innocently breaking” a promise, he can continue with the “illegal” behavior until it is comfortable for him to stop. For example, if he is eating from a bag of potato chips and suddenly remembers he promised to only have ten chips, but has had more, he will be allowed to make a follow-up promise to have 3 more chips, so that it is comfortable for him to stop.
      i) This “pressure releaser” rule is necessary because the primitive mind is so powerful that it could force him to break such promises, causing him to “innocently” fail.
   m) A rule that he must get busy doing other things during his promises (he can't just sit and watch the clock).
5) He is instructed and motivated to add more promises to his chain (Fig A, #5):
   a) He is encouraged to add more promises to his chain.
   b) He is motivated to add more promises to his chain. To motivate him, he is told the benefits of making promises and how it can help him obtain his goals:
      i) By keeping his promises easy and short-term, it's possible and even easy to keep them.
      ii) After keep each promise, he is completely free and relieved of all restriction, which relieves stress and feelings of deprivation. This is a great improvement over most diets, which require him to be deprived for days, weeks, months or even years on end!
      iii) Each promise “locks-in” better behavior.
      iv) Any promise to do better is an improvement.
      v) If he makes a lot of little improvement promises, it can add up to real progress towards his goal. (The program gives many ideas for making very easy, yet very effective promises.)
      vi) Any time he feels strong, he can “lock-in” a promise for better behavior.
      vii) He can make promises for any eating improvements that he can think of—the possibilities are limitless!
      viii) The chain of promises has a doable, lasting quality that can finally make it possible for him to succeed at weight loss! (All participants of the test group said that they could easily maintain their control indefinitely—even those who gave up previously on diet after diet!)
6) He is told what to do if he breaks a promise. Actual penalties are listed in the rules) (#4j above).
   a) Two buttons will be available for the individual to push if he breaks a promise (Fig. K).
      i) The “broken promise—excused” button (optional) is to be used if he breaks a promise, but was excused per the rules.
         (1) There is no penalty for breaking a promise if excused by the rules, such as if he “forgets” to keep a promise, although the software will keep track these and prompt him to take action to reduce these occurrences, if they happen too frequently.
            (a) Such action might be to write as down his promises to help him remember them.
      ii) The “broken promise—not excused” button is to be used if he breaks a promise and is not excused or innocent per the rules.
         (1) Penalties for breaking promises without being excused by the rules include losing privileges of making promises for 24 hours, negatively affects on his promise score, etc.
   b) Note: The program may assume that all promises are kept unless he pushes one of these buttons. (In the clinical trials, almost all participants could easily remember when they broke a promise.)
      It is worth mentioning that the App of the present invention can be downloaded or installed into any smart phone with different operation systems, wherein all the information will shown in the touch screen of the smart phone. For example, the display of “promise time” will be shown on the touch screen of the smart phone. Three different touch buttons, a time setter, an “excused broken promise” button and an “unexcused broken promise” button“, will also be provided on the touch screen of the smart phone. The time setter is provided for the user to selectively adjust the promise time. As it is mentioned above, the “excused broken promise” button” is to be used if he breaks a promise, but was excused per the rules. The “unexcused broken promise” button” is to be used if he breaks a promise and is not excused or innocent per the rules.
      Furthermore, the activator 10 can be wirelessly linked to the personal computer and/or the smart phone via any wireless link such as Bluetooth, Wi-Fi, infrared, or Radio frequency, such that when the activation button 11 is actuated, the present invention installed into the personal computer and/or the smart phone will be notified to start the promise and seal it to the chain.
      It is worth mentioning that the present invention may not notify the user once promise times are up, to help the user extend his abstention (the non-eating time) as long as possible. (If fat Albert has made a promise to only have one small piece of pie for 3 hours, reminding him when the three hours is up is like ringing the dinner bell! If he is not reminded, he may not think about having more pie for another hour or longer, which can be beneficial!) However, the device may notify the user when certain kinds of promises are over, if desired, such as promises to do exercise.
      When the user checks the promise time, the present invention will show the initial promise time that the user made and the required term of each promise. An alternate embodiment may show his abstention time (the amount of time the user actually abstained); and have an “overtime monitor” that displays his total time extensions, to encourage him to extend the behaviors of his promises.
7) The individual is assisted in making a strong commitment to keeping the promises he adds to his chain (Fig A., #6). Any or all of the following methods may be used: (“Promises” refers to the promises he adds to his chain of promises.)
   a) The Promise Score Display, which displays his Promise Score (ratio of promises kept to those broken). (Fig. G.)
      i) The program informs him that every promise he adds to the app will be accounted for by the app, which will record whether or not he keeps each promise and give him a ratio score of promises made to promises kept.
      ii) He is encouraged to keep his score as high as possible.
         (1) As one way to encourage him, he may be told that he cannot reset his score or start over, so he can permanently damage his score by breaking any promise.
            (a) His score may be for the lifetime of his use of the App; or for a specific term; or for a certain number of promises; or it may be reset with a code given to his doctor, instructor, or coach; or to him under “excusable” conditions, such as a major misunderstanding that caused him to break promises which is now understood.
      iii) The “Promise Score Display” is described to him (Fig. G.). It displays:
         (1) The total number of promises he has added to his chain.
         (2) The number of broken promises—not excused.
         (3) Optionally: the number of broken promises-excused.
         (4) The program will recalculate and display changes to his promise score.
      iv) His Promise Score(s) may be posted on the face of his app, other devices and on social network programs, to further motivate him to keep his score as high as possible.
   b) By describing the benefits of keeping his promises:
      i) If he reliably keeps his promises, he will be able to reliably program his mind to help him keep his promises, for all the benefits described in the Specification.
   c) By reminding him that it's easy to keep his promises:
      i) He is reminded that he doesn't have to make any promises; he only has to keep the ones he decides to add to his chain; and he only has to make easy promises.
      ii) He may be asked to admit to himself that he can keep all of the promises he adds to his chain, unless excused by the rules.
   d) By teaching him that there is nothing stressful or unnatural about committing to do things. People easily and naturally make commitments throughout life. They simply make a decision, which can be easily and comfortably maintained as long as it is easy enough to do and the consequences (having too much to lose to break the decision) are sufficient to maintain it. (Examples include the commitment to always add detergent to loads of wash, to avoid stains and dirty laundry; and the commitment to drive in the legally designated lane, to avoid getting in auto accidents.)
   e) By asking him to “decide” (or make up his mind) to keep his promises.
      i) He is taught that “decisions” can program the mind—although it takes having “too much to lose” to maintain the decision, as described in “d)” above.
      ii) The benefits of deciding (making his mind up) to keep his promises are explained to him:
         (1) As long as his mind is made up to keep his promises, so that he fully intends to keep them, this will enable him to cross the “threshold of sureness” that is required to program his mind to help him keep them. (Yes, it's a circle: one must create the “sureness” that he will follow the behavior that he wants to program his mind to help him follow.)
         (2) It is explained to him that programming his mind to help him keep his promises will make it much easier for him to keep his promises and give many additional benefits (as described in the Specification).
   f) By teaching the individual that the consequences of breaking promises must be strong enough to keep him comfortably and confidently sure that he will intend to keep every promise he adds to the device (just like the consequences of losing his credit keep him comfortably and confidently sure that he must make every car or house payment). After experiencing the incredible boost that super willpower gives, losing it often becomes too much for the user to lose! Then he is taught the vital concept that he will lose it if he even intends to allow exceptions in keeping his promises, even occasionally (for it's not possible to intend to allow exceptions and be sure at the same time). This keeps him comfortably and confidently sure that he must keep every promise he adds to the device.
   g) By teaching the individual the consequences for breaking promises:
      i) Each time he breaks a promise, he is teaching his mind not to take his promises seriously. Once his mind learns this, he can lose his precious personal control permanently!
         (1) For most people in the program, this is “too much for them to lose” and a very strong deterrent for breaking promises! (Note: the 1% in the clinic who allowed themselves to break promises had to start fighting their minds to keep their promises within a couple of weeks—and it soon became extremely difficult and unpleasant for them to keep them! But the 99% who simply made up their minds to keep their promises maintained super willpower for keeping them indefinitely—even those who were tracked for years!)
      ii) If he even seriously intends to break promises, he has already lost the sureness required to program his mind, since it's not possible to intend to break promises and be sure that he won't at the same time.
         (1) Therefore, if the individual values the ability to program his mind to help him follow behaviors that his primitive mind would otherwise fight, he has to make up his mind to keep his promises, so that he intends to keep them!
   h) By giving him assignments to help him experience the ease, comfort and control of following his plans while his mind is programmed to help him follow them.
   i) By telling him it's his responsibility to keep his promises, so that he feels responsible to take care when making and keeping them.
   j) By pointing out that keeping his promises is a small price to pay for the benefits of being able to program his mind to help him keep his promises.
   k) By teaching him that the Shield Method uses the same method that the mind naturally uses for easy, comfortable, reliable personal control; and that man-made methods are not as effective, since they force people to fight their minds.
      i) The current obesity epidemic is proof that failure is likely with current methods, like diets, that require people to fight their minds in order to try to stick to them.
   l) By teaching him that he probably won't be able to succeed at his goal if he has to fight his mind because of how powerful the mind is.
      i) Failure is almost certain (or much more likely), when a person has to fight his mind to follow a plan, because of it's powerful mind-tools, whereas;
      ii) Success is nearly guaranteed (or much more likely) when his mind is programmed to help him follow his plan.
   m) By reassuring him he isn't expected to be “perfect,” to set him at ease.
      i) He is told that it will not always be “extremely easy” to keep every promise he adds to his chain. Sometimes it will be a little difficult not to have that second delicious roll that he promised not to have for 30 minutes after he finishes the first. This is why it's important for his promises to be easy and short-term, because he may have to use a little ordinary willpower to keep this promise. But since the promise is easy and short-term, he only has to “tough it out” for a short time—not days, weeks or years, as he would on a diet or other weight loss method. Keeping the easy promise helps him stay in control; and afterwards, he is completely free to have more.
         (1) He is encouraged to have just a little more for another 15 minutes. This and other techniques described in the “Technique and Tips” section, below, help him stay in control even after his promises are over.
      ii) He is told that if he's like most “Shielders,” he will occasionally break some promises—nobody is perfect!
         (1) In which case, he must pay the 24 hour penalty, per the rules. (We have found that depriving Shielders of their precious personal control for 24 hours is the most effective penalty for helping them learn to appreciate it.)
   n) By pointing out that the commitment doesn't have to be constant. We sometimes daydream and flirt with ideas of breaking all kinds of commitments, such as missing a day of work. But if we conclude that we have too much to lose to skip the day, the desire to keep our job will kick in and program our mind to help us go to work. In the same way, Shielders sometimes think about breaking a promise—it's allowed, and completely natural! But once we conclude that we can't, because losing our precious control is too much for us to lose, our mind will kick in and help us keep the promise.
      i) The Shielder is encouraged to make a long-term decision to keep his promises, like he may make a long-term decision to take the trash out every week, to avoid having to fight many mind battles about it.
   o) One of the most effective strategies in the clinic was asking individuals to make “keeping their promises” a part of their character—a part of “who they are,” so that once they make a promise it is tied to their character. This is one reason why we refer to the “behavior plans” as “promises.” The individual often develops a deep personal commitment to keeping his promises, to the point that it becomes part of his moral fiber and is part of what defines him. The individual then has a personal stake in keeping them and feels that he has too much to lose to break them, since his commitment adds so much value (personal control) to his life.
   p) By creating Categories and/or Levels that he may attain.
      i) As his knowledge and skill progresses, we say that his “Shield” goes from paper (the least amount of protection), to cloth, to wood, to tin, to metal and finally to sterling silver. (The Sterling Shield is the highest level, giving the greatest comfort and protection.)
      ii) Three categories are used, based on how much more the person eats after his promises.
      iii) These levels and categories may be displayed on the face of his devices (iPhone, etc.) or on social networks such as “Facebook” (Fig. I).
   q) By describing how his “chain of promises” makes it more difficult for his mind to fight his personal plans:
      i) Without the chain, his mind is free to FIGHT the behavior plans he makes by:
         (1) Using the “procrastination rationalization”: he can easily rationalize that he can “make up” for breaking any plan later. For example, if he makes a plan to exercise for an hour “today,” his mind will be free to FIGHT his plan by helping him rationalize that he can skip his exercise “today,” and make up for it “later.”
         (2) His mind will also be free to fight his plan by helping him rationalize that he has good enough excuses to break his plan or that he has “more important” things to do.
      ii) With the chain of promises, his mind cannot so easily fight his plans because:
         (1) By linking every promise to a chain, it's not just one promise he is breaking or one misdeed that he can easily make up for, but his entire chain—which he gives him the ability to program his mind to help him follow plans that his primitive mind would otherwise fight. In other words, breaking a promise won't just result in missing one day of exercise that he can rationalize he can make up for. It puts his chain, his ability to program his mind, his control and his ability to succeed in jeopardy. For most Shielders, that's just too much to lose!
   r) By using the “Locking Mechanism” (Fig B—also described on page 30): Most of the above methods for creating a commitment to keeping promises contribute to the “Locking Mechanism,” as described in the original patent application for this invention. (Although through the years I believe I have learned to describe my original invention more clearly, it is still the same invention.)
      i) The “Locking Mechanism” concept:
         (1) Since it is EASY, therefore POSSIBLE, for the individual to keep his promises; (and)
         (2) Since he must INTEND to keep every promise he adds to his chain in order to program his mind (referred to as activating “Mental Shields” in the original application) consistently; (and)
         (3) Since he values (and wants to PROTECT) his ability to program his mind consistently, for the benefits of increased success rates, increased comfort, ease, self esteem, progress and decreased stress:
         (4) The result is: he makes his mind up not to make any promises unless he INTENDS to keep them, which enables him to program his mind reliably and at will. (In other words, he gets “locked-in” to keeping his promises.)
         (5) Note: There has been some confusion about the “absolute sureness” spoken of in the original application. This happens at the moment a person “decides” to keep (or go ahead with the behavior of) his promise—it does not mean that the individual is “always” sure that he will keep every promise, any more than he is always sure that he will go to work every day. This sureness is the “go-ahead” by the ego division of the mind, once a decision is made to keep a promise (as was described in the scientific explanation of the original application). The sureness may waver and only become firm seconds before actually keeping a promise.
8) Committing to keep his promises gives the user of the App reliable personal control. Now he is taught the “Promise Techniques” which enable him to use the “leverage” of his reliable control for easy, comfortable and consistent control (Fig. A, #7).
   a) He is taught that short-term promises can be very effective. For example, 15 minute promises can be very effective, for the following reasons:
      i) Stopping for 15 minutes stops the hand-to-mouth reflex and fools our mind and body into thinking we are done eating—it's just how we are wired. This makes it easier to eat less.
      ii) Taking a 15 minute break helps us stay in control and gives hot desires a chance to cool down. There are 900 seconds in 15 minutes. If we feel strong for even one of those seconds, or realize that what we were eating wasn't very good, we can lock in a promise to stop. Before, we would have eaten the whole thing and then regretted it.
      iii) Waiting 15 minutes allows time for food to reach our stomach and register sensations of fullness and satisfaction.
      iv) After the 15 minutes, we usually feel refreshed instead of stuffed or sick and ready for a nap—and we start to prefer feeling this way after eating!
      v) even when we were certain that we would!
      vi) After 15 minutes, our food may be less appealing (cold, wilted, etc.) and this makes it easier not to have more. (After awhile, this doesn't matter because most Shielders “grow out” of having more—or they're usually fine with just a little more.)
      vii) The primitive mind puts up less resistance to shorter promises because instant gratification is obtainable sooner. So these promises are very easy to make, yet so effective at keeping us in control that we say we have “already won” by making them!
   b) He is taught techniques that enable him to use the methods that the primitive mind uses “in reverse,” for easy, comfortable, reliable and effective personal control.
      i) The primitive mind craves instant gratification, so it endeavors to make “feast now, fast later” deals with the over-eater, causing him to eat excessively when he eats. Such a deal is, “If you eat another big piece of pie now, you can make up for it by dieting all next week.” This is how his primitive mind has been fooling him into eating too much! These deals are unhealthy (it's unhealthy to eat so much) and unreliable (since the primitive mind is likely to fight them and work for another quantity deal the very next time he is tempted)! But now that the person has the ability to add promises to his chain that he won't ordinarily break, he can reverse this deal by making “fast now, feast later,” promises: “If I eat just half a piece of pie now, I can have more, if I want, in 30 minutes.” In this way, he reverses the trick played by his primitive mind so he eats less. Using such promises to delay quantity is much healthier and helps him stay in control, for all the reasons described above in #7a. Also, the rules of making promises stipulate that he must get busy doing other things during his promises (he can't just sit and watch the clock). And he is encouraged to make a promise to have just a couple more bites if he really wants more after the 30 minutes. The leverage, rules and reliable control that his chain of promises gives helps him stay in control and even to lose his fear of losing control, reducing stress and anxiety greatly!
   c) He is taught techniques for “consistent” control:
      i) With one important technique for consistent control, he promises to eat half as much food each time one eats for 15 minutes (the H15 technique). In other words, he will make promises to eat no more than half as much (put half as much on his plate) and wait 15 minutes before eating more (the 15 minutes starts after eating the half).
         (1) This technique is effective for the reasons described above in #8a.
         (2) He may be assisted in committing to use the H15 technique every time he eats; using many of the same principles used to commit to keeping his promises (described in Step 7 of this Outline of Lessons and Assignments). This helps ensure that he makes “our best promise” every time he eats, which can give him more consistent control.
            (a) A benefit of committing to the H15 technique is that it simplifies the entire program for him, since this is the only promise he needs to make! Committing to this technique ensures that he will make a great promise every time he eats and usually results in eating less than he would have. (Of course, as he is warned: for the over-eater, trying to eat half may feel like “unbearable deprivation” unless his mind is programmed to help him do so!)
            (b) We have special rules and tips for this technique (which three entire lessons are devoted to), such as how to estimate and eat half as much in every kind of situation. Here as some of the rules:
            (i) The 15 minutes starts after he has finished eating.
            (ii) Put the rest of the food away, out of sight, before starting to eat. This helps us get involved with non-eating activities. We often forget to have more for hours!
            (iii) If we want more, ask ourselves how much we really want. Often a couple more bites is all we need. If so, be sure to lock it in with a promise!
            (iv) Eat in a civilized manner. This helps us enjoy our food more than wolfing down excessive amounts without really tasting it; which helps us learn to enjoy less food more than excess.
9) ADDITIONAL LESSON MATERIALS, RAMIFICATIONS AND FUNCTIONS OF THE DEVICE (FIG A, #8, 9):
   a) The individual may be taught a unique Terminology associated with the Shield Method, based on the word “Shield,” which can be used in the traditional sense, to mean “protect,” or to mean “program” or “super personal control.”
      i) He is told, for example, “You will be able to Shield (or program) your mind to make you comfortable with just one scoop of ice cream—and this will Shield (or protect) you from feeling deprived without more. Your plan to have just one scoop will then be Shielded (or protected). You will be able to use your Shield (your super personal control) to easily and comfortably lose weight and to achieve many other personal goals. A Mental Shield is a programmed state of mind, which is acting to protect a person, plan, behavior or a belief. In addition, those who learn and use the Shield Method are called Shielders®.”
   b) The app may also teach the individual to distinguish between the 2 types of willpower:
      i) With ordinary willpower, a person has to fight his mind in order to do something. An example is sticking to a traditional diet. The dieter has to fight his mind as it tries to tempt him to eat the foods or quantities that are not allowed on his diet. This kind of willpower is difficult and stressful to use—and it's extremely unreliable! (People cheat on their diets and fail daily!)
      ii) With super willpower, a person doesn't have to fight his mind to do something; in fact, his mind helps him. This makes it super easy and comfortable to do, and gives super high success rates. An example is driving on the correct side of the road. People don't have to fight their minds to do this; their minds help them, giving a super success rate—most people always stay on their side of the road!
   c) Information about the three divisions of the mind:
      i) The primitive id (inner child) division of the mind.
         (1) Information about the nature of the id, which is ruled by the “pain and pleasure” principle.
         (2) Information about the “mind tools” that the primitive mind can and does use to stimulate people to act to obtain things that they find desirable.
         (3) How the primitive mind and/or ego uses the “mind tools” when the mind is programmed to help him resist temptations.
         (4) Techniques which use the actions of the primitive mind for enhanced behavior control.
         (5) A cartoon character named “Id the Dragon” may be used to represent the primitive mind and to illustrate lessons and concepts and for promotional purposes.
      ii) Information about the ego (inner adult) division of the mind.
         (1) Information about the nature of the inner adult, which can over-ride the inner child when the individual feels that he has “too much to lose.”
         (2) A cartoon princess character may be used to represent the ego division of the mind and to illustrate lessons in various ways.
         (3) How the inner adult can gain better control of the inner child, using the leverage of the chain of promises.
         (4) A cartoon character named “Judge Ego” may also be used to represent the ego division of the mind and to illustrate lessons and concepts and for promotional purposes.
      iii) Information about the super ego division of the mind.
         (1) Information about the nature of the super ego, which serves as a person's conscience and reservoir of information about why a person should and should not behave certain ways.
         (2) A jury of cartoon characters may be used to represent the super ego division of the mind and to illustrate lessons and concepts and for promotional purposes.
   d) Information about nutrition, exercise and/or metabolism.
   e) The program may track and make the individual aware of patterns, problem times and progress.
   f) The program may periodically give other motivational and encouragement messages (such as notifying him that he can make a better promise in a certain situation).
   g) The program may give reminders and suggestions (such as reminders he has scheduled and suggestions to make specific promises in certain situations).
   h) The program may notify the person if he is breaking a rule; if he is in a “danger” time period or situation in which he typically has problems over-eating; if he has a misunderstanding of a basic concept of the program, etc.
   i) The program may have lists or checklists of promises the individual may choose from.
   j) The program may teach specific techniques and tips for creating new habits.
   k) The program may teach specific techniques and tip for accomplishing “do” behavior goals (such as chores and special projects).
      i) One “do” behavior technique is called the D15. The individual makes a promise to do something just for 15 minutes. Not only will he get at least 15 minutes done, but, as we have discovered, getting started is half the battle!
   l) The program may teach specific techniques and tips for accomplishing other “don't” behavior goals (such as don't bite your nails).
      i) Effective techniques for this include the delay techniques, such stopping for 15 minutes. 15 minutes stops the “hand to mouth” reflex and gives food time to register feelings of fullness and satisfaction, etc.
   m) The program may enable individuals to make promises, under the supervision of a psychologist, to endure situations that they find difficult; so that they can experience it while their mind is programmed to help them endure it, rather than fighting their efforts to do so.
   n) This method is also unique in that it enables people to program their minds for any behavior they add to their chains—the possibilities are limitless!
   o) Many current methods may be improved by the Shield Method. For example, the “time out” can be improved with a promise. We have even found that naps can be more restful by making term promises, since we don't have to fight mind battles that urge us to keep getting up! One individual said that he was able to use “delay” promises to cure himself of masturbating whenever he was alone.
   p) The program teaches other specific techniques, as well as tips, for controlling the primitive mind
   q) The program provides “inspiration lists” or “checklists” of things to do, ideas and goals, designed to inspire the user to make promises that will help him accomplish his goals.
   r) The program may have lists of new “dream habits” that the person may choose to establish.
   s) The program may have a promise calendar, which shows the promises he is schedule to keep.
      i) He may be able to schedule promises directly into the calendar.
   t) The program may have a capability for the individual to log his daily activities and/or activities related to his goals (such as what he eats).
   u) The program may have a capability for him to log his “Guilt's” and/or “Gloats”: things he feels “guilty” about doing and/or things he feels “proud” of doing.
   v) The program may have a Trouble Shooter that may be used if the person has a problem or question.

The final result is that the individual is able to maintain the sureness that he will keep the promises he adds to the device, with a high degree of reliability, so that he can program his mind “at will” to help him follow the behaviors of his promises, easily, comfortably and with a high degree of reliability. Highly documented and audited clinical tests showed that all participants were able to create and maintain the sureness to keep the promises they added to their chains; and that this programmed their minds so that it significantly reduced having to fight their minds to follow improved behaviors.

One skilled in the art will understand that the embodiment of the present invention as shown in the drawings and described above is exemplary only and not intended to be limiting.

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A method of tracking promises from a user, comprising the steps of:
(a) providing a learning and training phase to the user, wherein in said learning and training phase, one or more lessons are given to the user regarding effective promise techniques, and one or more assignments for the user to complete regarding said promise techniques, wherein an assignment score of the user is determined regarding a completeness of said assignment;
(b) recording a plurality of viable promises made by the user in a chainlike manner to form a promise chain;
(c) guiding the user to keep each of said viable promises from said promise chain, wherein the user is enable to make said viable promise to endure situations that the user finds difficult, so as to guide for helping the user endure the difficult to keep said viable promises; and
(d) determining a promise score of the user regarding to said promise chain, which is an incentive to motivate the user to keep said promise score as high as possible, wherein when one of said viable promises is broken, said promise chain is then broken to have a negative affect on said promise score.

2. The method, as recited in claim 1, wherein the step (a) further comprises a step of monitoring a level of sureness of the user for ensuring the user is able to keep said viable promises, wherein when said level of sureness drops, lesson material and suggestions are provided to help restore the sureness of the user.

3. The method, as recited in claim 1, wherein the step (d) further comprises a step of when said viable promise is broken, determining said broken promise is whether an excused broken promise or an unexcused broken promise, wherein only said unexcused broken promise has the negative affect on said promise score.

4. The method, as recited in claim 3, wherein said excused broken promise and said unexcused broken promise are selected by the user.

5. The method, as recited in claim 1, wherein said promise score contains information selected from the group consisting of total promises added to chain, total broken promise, and percentage of successful promise.

6. The method, as recited in claim 1, wherein said assignment score contain information selected from the group consisting of total number of assignments given, total number of assignments completed satisfactorily, percentage of assignments completed satisfactorily, number of retake assignments given, number of retake assignments completed satisfactorily, and percentage of retake assignments satisfactorily completed.

7. The method, as recited in claim 1, before the step (a), further comprising a step of providing a baseline documentation phase prior to starting said learning and training phase, wherein in said baseline documentation phase, a plurality of personal, health, and habitual questions are given for the user to answer in order to obtain a personal control score for evaluating what kind of lesson and assignment are given in learning and training phase.

8. The method, as recited in claim 7, before the step (a), further comprising a step of providing an introductory phase prior to starting said baseline documentation phase, wherein in said introductory phase, information is provided for helping the user establish said promise chain, for teaching the user how to make promise techniques, and for guiding and motivating the user to succeed.

9. The method, as recited in claim 1, wherein the step (a) further comprises a step of allowing the user to retake said assignment and providing a “panic button” for the user to access that results in lesson material, tips and suggestions to be provided for helping restore the confidence of the user.

10. The method, as recited in claim 1, which is displayed and operated by an electronic device.

11. The method, as recited in claim 1, wherein the step (c) further comprises a step of periodically giving motivational and encouragement messages to the user to endure the difficult.

12. The method, as recited in claim 1, wherein each of said viable promises has a time length for the user to keep.

13. The method, as recited in claim 1, wherein the first viable promises of said promise chain is set for the user to easy to keep in short term.

14. A device for tracking promises from a user, comprising:
a first memory module storing a learning and training phase to be displayed, wherein in said learning and training phase, one or more lessons are stored for giving to the user regarding effective promise techniques, and one or more assignments are stored for the user completing thereof regarding said promise techniques;
a second memory module storing a plurality of viable promises made by the user in a chainlike manner to form a promise chain;
a third memory module storing guidance information for guiding the user to keep each of said viable promises from said promise chain, wherein said guidance information is arranged for enabling the user to make said viable promise to endure situations that the user finds difficult, so as to guide for helping the user endure the difficult to keep said viable promises; and
a processor module for determining an assignment score of the user regarding a completeness of said assignment, and for determining a promise score of the user regarding to said promise chain, wherein said promise score is an incentive for motivating the user to keep said promise score as high as possible, wherein when one of said viable promises is broken, said promise chain is then broken to have a negative affect on said promise score.

15. The device, as recited in claim 14, wherein said first memory module further comprises means for monitoring a level of sureness of the user for ensuring the user is able to keep said viable promises, wherein when said level of sureness drops, lesson material and suggestions are provided to help restore the sureness of the user.

16. The device, as recited in claim 14, wherein when said viable promise is broken, said processor module further comprises means for determining said broken promise is whether an excused broken promise or an unexcused broken promise, wherein only said unexcused broken promise has the negative affect on said promise score.

17. The device, as recited in claim 16, further comprising an input means for the user selectively inputting said broken promise as one of said excused broken promise and said unexcused broken promise.

18. The device, as recited in claim 16, wherein said promise score contains information selected from the group consisting of total promises added to chain, total broken promise, and percentage of successful promise.

19. The device, as recited in claim 16, wherein said assignment score contain information selected from the group consisting of total number of assignments given, total number of assignments completed satisfactorily, percentage of assignments completed satisfactorily, number of retake assignments given, number of retake assignments completed satisfactorily, and percentage of retake assignments satisfactorily completed.

20. The device, as recited in claim 16, wherein said first memory module further stores a baseline documentation phase, wherein said baseline documentation is given prior to starting said learning and training phase, wherein in said baseline documentation phase, a plurality of personal, health, and habitual questions are stored for giving to the user to answer, wherein said processor module determines a personal control score for evaluating what kind of lesson and assignment are given in learning and training phase.

21. The device, as recited in claim 16, wherein said first memory module further stores an introductory phase, wherein said introductory phase prior to starting said baseline documentation phase, wherein in said introductory phase, information is stored for helping the user establish said promise chain, for teaching the user how to make promise techniques, and for guiding and motivating the user to succeed.

22. The device, a recited in claim 16, which is a program being operated by an electronic device.
